(19) United States
(12) Patent Application Publication
(10) Pub. No.: US 2021/0238505 A1
(43) Pub. Date: Aug. 5, 2021

(54) AMYLASE SYNERGY WITH OXYGEN BLEACH IN WAREWASH APPLICATION

(71) Applicant: ECOLAB USA INC., Saint Paul, MN (US)

(72) Inventors: Johnny Zhengrong Liu, Saint Paul, MN (US); John Mansergh, Saint Paul, MN (US); Stephan Hubig, Saint Paul, MN (US); Maricia Pacheco, Saint Paul, MN (US); Tobias Foster, Cologne (DE)

(21) Appl. No.: 17/248,564

(22) Filed: Jan. 29, 2021

Related U.S. Application Data
(60) Provisional application No. 62/968,225, filed on Jan. 31, 2020.

(51) Int. Cl. C11D 3/386; C11D 17/04; C11D 11/00; C11D 3/30; C11D 3/06

(52) U.S. Cl. CPC C11D 3/38618; C11D 17/042; C11D 3/06; C11D 3/30; C11D 11/0023

(57) ABSTRACT

The present disclosure relates to detergent compositions effective for soil removal, particularly for the removal of starch soils. The compositions described herein may be used to remove soil from a surface including both hard and soft surfaces, most preferably on ware. Preferably, the detergent compositions comprise a detergent, a bleach, and an enzyme. Methods of making and using the detergent compositions for the removal of starch are also described herein.

### CROSS-REFERENCE

This application is related to and claims priority under 35 U.S.C. § 119 to U.S. Provisional Application Ser. No. 62/968,225 filed on Jan. 31, 2020, and entitled “AMYLASE SYNERGY WITH OXYGEN BLEACH IN WAREWASH APPLICATION”; the entire contents of this patent application are hereby expressly incorporated herein by reference.

### TECHNICAL FIELD

The present disclosure relates to detergent compositions effective for soil removal, particularly for the removal of starch soils. The detergent compositions comprise an amylase and an oxygen source. Methods of making and using the detergent compositions are also provided herein.

### BACKGROUND

Effective cleaning is a crucial component of many industries; there can be severe consequences if not done properly. Cleaning involves the removal of soils and residues from surfaces, leaving them visually clean. Disinfection, the removal of microorganisms, may follow cleaning. However, for disinfection to be effective thorough cleaning must first occur. Generally, a cleaning regime involves rinsing away debris, cleaning using detergents and rinsing again. The detergent used to remove soil often depends on the type of soil present and the type of surface.

Typical surfaces in need of soil removal including food processing surfaces, hard surfaces including warewashing surfaces, and laundry/textile surfaces, among others. The most common soils include proteins such as meat, egg, milk, keratin; carbohydrates such as sugar, cellulose, and starch; oils such as animal fats, vegetable oils, sebum, mineral oil, and grease; other food product soils; urea and minerals, such as compounds containing calcium and magnesium, to name a few. Starch removal in particular can pose a challenge. Starch-based soils can accumulate on surfaces, becoming increasingly difficult to remove. For example, starchy soils may accumulate on ware, including for example, eating utensils, plates, bowls, pots, pans, glassware, and the like. Ware can be made of ware glass, plastic, ceramic, and/or metal. Starchy soils may also accumulate on a laundry surface, including for example napkins, tablecloths, uniforms, towels, linens, and the like. If starch soils are not successfully removed from an article during a first cleaning cycle, the starch becomes more deeply embedded or strongly adhered to the surface of the article, increasing the difficulty of removal. Adhered and embedded starch soils are also more likely to attract additional soil, leading to build up over time. This adhered and embedded buildup often cannot be removed by conventional washing compositions and methods. Such soils must then be removed by thorough manual cleaning and/or higher concentrations or quantities of a cleaning composition. Manual cleaning is time consuming, and the use of higher quantities of detergent composition can erode surfaces over time, leading to the need to replace articles more frequently. Both contribute to higher costs and decreased efficiency.

Conventional detergents are frequently phosphate-based, highly alkaline compositions comprising a chlorine bleach. However, the high alkalinity and the chlorine bleach have proved to be too aggressive and hazardous for common use. There is therefore a growing interest in replacing these compositions with detergents operable under less alkaline and gentler (chlorine free) bleaching conditions.

For example, U.S. Pat. No. 8,092,613 seeks to remove starch buildup by using several compositions applied is several steps. U.S. Pat. No. 8,092,613 involves treatment with a first alkaline detergent composition, a second acidic composition, and an additional treatment with the alkaline detergent composition. These compositions are administered separately, and in some cases are stored separately. The use of multiple compositions increases cost and decreases efficiency.

U.S. Pat. No. 9,969,958 teaches a detergent composition for removing soil using a bleach catalyst and mild alkaline detergent materials, such as sodium carbonate, rather than harsher caustic materials. However, U.S. Pat. No. 9,969,958 fails to consider or appreciate the interaction between an enzyme and bleach composition.

U.S. Pub. No. 2018/0044613 is focused on the removal of protein soils, which differ from starch soil removal. As such, U.S. Pub. No. 2018/0044613 relies on the interaction between MGDA, GLDA, and an alkali metal tripolyphosphate to provide improved removal of soils. U.S. 2018/0044613 does not appreciate the interaction between bleach components and enzymes to substantially enhance starch soil removal.

U.S. Pub. No. 2018/0216041 combines a bleach catalyst together with MGDA, GLDA, and an alkali metal tripolyphosphate to provide improved removal of soils. However, like U.S. 2018/0044613, U.S. 2018/0216041 provides only a brief discussion of enzymes, as they are optional. U.S. 2018/0216041 also fails to teach the insight regarding the interaction between bleach components and enzymes to substantially enhance starch soil removal.

In sum, existing compositions fail to successfully combine enzymes with detergent compositions containing active bleach components such as oxygen sources and bleach activators. This is because many compositions using bleach components—whether chlorine bleaches or the gentler percarbonate bleaches—are incompatible with enzymes. Often when an enzyme is combined into a detergent composition containing bleach components, the enzyme is inactivated fully, leading to no improvement in soil removal, or partially leading to minimal improvement in soil removal. Little or no improvement in soil removal efficacy typically does not justify adding an enzyme to the composition as the benefits provided by the enzyme are outweighed by the cost of the enzyme itself and the cost of still needing to use a high quantity (or concentration) of the other soil removal components. The benefits of enzyme use have in the past been further minimized by the problem of enzyme stability: without an enzyme stabilization system (which adds to the cost of the composition overall) many enzymes degrade over time or cannot otherwise be easily incorporated into dimensionally stable solid block compositions.

As a result, there is a need to develop detergent compositions which utilize mild alkaline detergent materials but still provide effective soil removal on stubborn soils, such as starch soils.

There is also still a need to develop detergent compositions that combine bleach components—such as oxygen sources and bleach activators—and enzymes without leading to the complete or partial inactivation of the enzyme.

There is a further need to develop detergent compositions combining bleach components and enzymes that are dimensionally stable, permitting the composition to be produced and stored as a solid block.

There is a still further need to develop mild alkaline detergent compositions which remove stubborn soils in as few as one wash cycle.

There is also a need to develop detergent compositions capable of removing stubborn soils in a more cost-effective manner.

It has surprisingly been found that a detergent composition comprising an alkali metal carbonate as a source of alkalinity, a peroxygen source, an iron or manganese peroxidation catalyst, and an amylase enzyme is not only stable and cost-effective but provides a synergistic soil removal on stubborn soils, such as starch soils.

### BRIEF SUMMARY OF THE PREFERRED EMBODIMENTS

A preferred embodiment is directed to a detergent composition comprising an alkalinity source, one or more surfactants, an oxygen source, a bleach activator, an amylase, and one or more chelating agents. In a most preferred embodiment, an additional enzyme is also included.

A preferred embodiment is directed to a method of cleaning a surface comprising combining a detergent composition comprising an alkalinity source, one or more surfactants, an oxygen source, a bleach activator, an amylase, and one or more chelating agents, with water to form a use solution; and contacting the detergent composition with a surface, wherein the surface is soiled with a starch-based soil; wherein the composition removes the starch-based soil.

### BRIEF DESCRIPTION OF THE FIGURES

FIG. 1 shows a comparison of soil removal demonstrated by a base detergent composition, a detergent+bleach composition, a detergent+enzyme composition, and a detergent+bleach+enzyme composition.

FIG. 2 shows the same comparison as FIG. 1, i.e., comparing the soil removal demonstrated by a base detergent composition, a detergent+bleach composition, a detergent+enzyme composition, and a detergent+bleach+enzyme composition, except FIG. 2 employs a different amylase species.

FIG. 3 evaluates the compatibility of various detergent compositions with amylase enzymes as evidenced by soil removal efficacy.

Various embodiments of the compositions will be described in detail with reference to the figures. Reference to various embodiments does not limit the scope of the invention. Figures represented herein are not limitations to the various embodiments according to the invention and are presented for exemplary illustration of the invention.

### DETAILED DESCRIPTION OF THE PREFERRED EMBODIMENTS

The compositions described herein relate to detergent compositions employing an alkali metal carbonate as a source of alkalinity, a peroxygen source, an iron or manganese peroxidation catalyst, and an amylase enzyme. The detergent compositions have many advantages over conventional alkali metal carbonate and/or alkali metal hydroxide detergents, and conventional detergents containing enzymes. For example, the detergent compositions described herein are stable and cost-effective, while providing substantially improved soil removal efficacy.

The embodiments described herein are not limited to particular enzyme-containing alkaline detergent compositions, which can vary and are understood by skilled artisans. It is further to be understood that all terminology used herein is for the purpose of describing particular embodiments only and is not intended to be limiting in any manner or scope. For example, as used in this specification and the appended claims, the singular forms “a,” “an” and “the” can include plural referents unless the content clearly indicates otherwise. It should also be noted that the term “or” is generally employed in its sense including “and/or” unless the content clearly dictates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range.

For clarity, certain terms are first defined. Unless defined otherwise, all technical and scientific terms used herein have the same meaning as commonly understood in the field. Many methods and materials similar, modified, or equivalent to those described herein can be used in the practice of the embodiments described herein without undue experimentation, the preferred materials and methods are described herein. In describing and claiming the embodiments described herein, the following terminology will be used in accordance with the definitions set out below.

The term “weight percent,” “wt. %,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt. %,” etc.

The term “about,” as used herein, refers to variation in the numerical quantity that can occur, for example, through typical measuring techniques and equipment, with respect to any quantifiable variable, including, but not limited to, concentration, mass, volume, time, temperature, pH, reflectance, etc. Further, given solid and liquid handling procedures used in the real world, there is certain inadvertent error and variation that is likely through differences in the manufacture, source, or purity of the ingredients used to make the compositions or carry out the methods and the like. The term “about” also encompasses amounts that differ due to different equilibrium conditions for a composition resulting from a particular initial mixture. The term “about” also encompasses these variations. Whether or not modified by the term “about,” the claims include equivalents to the quantities. The term “cleaning, “as used herein, refers to performing or aiding in any soil removal, bleaching, microbial population reduction, or combination thereof.

The term “substantially similar cleaning performance” refers generally to achievement by a substitute cleaning product or substitute cleaning system of generally the same degree (or at least not a significantly lesser degree) of cleanliness or with generally the same expenditure (or at least not a significantly lesser expenditure) of effort, or both.

As used herein, the phrase “food processing surface” refers to a surface of a tool, a machine, equipment, a structure, a building, or the like that is employed as part of a food or beverage processing, preparation, or storage activity. Food processing surface is intended to encompass all surfaces used in brewing (including beer brewing and preparation of liquors and spirits) and winemaking processes (e.g., bright beer tanks and lines, fermentation vessels, mash tuns, bottling equipment, pipes, and storage vessels). Examples of food processing surfaces include surfaces of food processing or preparation equipment (e.g., boiling, fermenting, slicing, canning, or transport equipment, including flumes), of food processing wares (e.g., utensils, dishware, wash ware, and bar glasses), and of floors, walls, or fixtures of structures in which food processing occurs. Food processing surfaces are found and employed in food anti-spoilage air circulation systems, aseptic packaging sanitizing, food refrigeration and cooler cleaners and sanitizers, ware washing sanitizing, blancher cleaning and sanitizing, food packaging materials, cutting board additives, third-sink sanitizing, beverage chillers and warmers, meat chilling or scalding waters, autodish sanitizers, sanitizing gels, cooling towers, food processing antimicrobial garment sprays, and non-to-low-aqueous food preparation lubricants, oils, and rinse additives.

As used herein, the phrase “food product” includes any food substance that might require treatment with an antimicrobial agent or composition and that is edible with or without further preparation. Food products include meat (e.g., red meat and pork), seafood, poultry, produce (e.g., fruits and vegetables), eggs, living eggs, egg products, ready to eat food, wheat, seeds, roots, tubers, leafs, stems, corns, flowers, sprouts, seasonings, or a combination thereof. The term “produce” refers to food products such as fruits and vegetables and plants or plant-derived materials that are typically sold uncooked and, often, unpackaged, and that can sometimes be eaten raw.

As used herein, the phrase “health care surface” refers to a surface of an instrument, a device, a cart, a cage, furniture, a structure, a building, or the like that is employed as part of a health care activity. Examples of health care surfaces include surfaces of medical or dental instruments, of medical or dental devices, of electronic apparatus employed for monitoring patient health, and of floors, walls, or fixtures of structures in which health care occurs. Health care surfaces are found in hospital, surgical, infirmity, birthing, mortuary, and clinical diagnosis rooms.

The term “hard surface” refers to any surface which is or has a component which is hard and typically non-or minimally porous, such as walls, floors, counters, tables, chairs, bed-pans, diagnostic instruments, trays, pans, holders, racks, forceps, scissors, shears, saws (e.g. bone saws and their blades), hemostats, knives, chisels, rongeurs, files, nippers, drills, drill bits, rasps, burrs, spreaders, breakers, elevators, clamps, needle holders, carriers, clips, hooks, gouges, curettes, retractors, straightener, punches, extractors, scoops, keratomes, spatulas, expressors, trocars, dilators, cages, glassware, tubing, catheters, cannulas, plugs, stents, scopes (e.g., endoscopes, stethoscopes, and arthroscopes) and related equipment, ware such as ovens, toasters, microwaves, shelving, food storage containers, drying racks, pans, pots, mixers, blenders, chef/food preparation knives, bowls, whisks, baking sheets, cutlery (knives, forks, spoons, etc.), plates, tongs, glasses, mugs, carafes, and the like, or combinations thereof. As used herein, the term “ware” refers to items such as eating and cooking utensils, dishes, such as ovens, toasters, microwaves, shelving, food storage containers, drying racks, pans, pots, mixers, blenders, chef/food preparation knives, bowls, whisks, baking sheets, cutlery (knives, forks, spoons, etc.), plates, tongs, glasses, mugs, carafes, and other hard surfaces such as showers, sinks, toilets, bathtubs, countertops, windows, mirrors, transportation vehicles, and floors, and the like. As used herein, the term “warewashing” refers to washing, cleaning, or rinsing ware. Ware may include materials comprised of metal, ceramic, china, and glass; “ware” also refers to items made of plastic. Types of plastics that can be cleaned with the detergent compositions described herein include but are not limited to, those that include polycarbonate polymers (PC), acrilonitrile-butadiene-styrene polymers (ABS), and polysulfone polymers (PS). Another exemplary plastic that can be cleaned using the detergent compositions include polyethylene terephthalate (PET).

The term “soft surface” refers to any surface which is not a hard surface, typically including a fabric surface, which refers to any knit, woven, and non-woven surfaces (such as surgical garments, draperies, bed linens, bandages, etc.), or patient-care equipment (such as respirators, diagnostic equipment, shunts, body scopes, wheel chairs, beds, etc.), or laundry surface.

As used herein, the term “laundry” refers to items or articles that are cleaned in a laundry washing machine. In general, laundry refers to any item or article made from or including textile materials, woven fabrics, non-woven fabrics, and knitted fabrics. The textile materials can include natural or synthetic fibers such as silk fibers, linen fibers, cotton fibers, polyester fibers, polyamide fibers such as nylon, acrylic fibers, acetate fibers, and blends thereof including cotton and polyester blends. The fibers can be treated or untreated. Exemplary treated fibers include those treated for flame retardancy. It should be understood that the term “linen” is often used to describe certain types of laundry items including bed sheets, pillowcases, towels, table linen, tablecloth, bar mops and uniforms.

As used herein, the term “free,” “no,” “substantially no” or “substantially free” refers to a composition, mixture, or ingredient that does not contain a particular compound or to which a particular compound or a particular compound-containing compound has not been added. In some embodiments, the reduction and/or elimination of hydrogen peroxide according to embodiments provide hydrogen peroxide-free or substantially-free compositions. Should the particular compound be present through contamination and/or use in a minimal amount of a composition, mixture, or ingredients, the amount of the compound shall be less than about 3 wt-%. More preferably, the amount of the compound is less than 2 wt-%, less than 1 wt-%, and most preferably the amount of the compound is less than 0.5 wt-%.

The methods and compositions described herein may comprise, consist essentially of, or consist of the components and ingredients enumerated in exemplary embodiments as well as other ingredients described herein. As used herein, “consisting essentially of” means that the methods and compositions may include additional steps, components or ingredients, but only if the additional steps, components or ingredients do not materially alter the basic and novel characteristics of the claimed methods and compositions.

Compositions According to an embodiment, the compositions preferably include a source of alkalinity, a peroxygen source, an iron or manganese peroxidation catalyst, and an amylase enzyme, along with additional chelants, water conditioning agents, surfactants, corrosion inhibitors and additional functional ingredients as desired. In a most preferred embodiment, an additional enzyme is included in the compositions.

Further description of suitable formulations is shown in Tables 1 and 2:

TABLE 1

| | Example | Example | Example | Example |
|---|---|---|---|---|
| | Range 1 | Range 2 | Range 3 | Range 4 |
| Formulations | (wt. %) | (wt. %) | (wt. %) | (wt. %) |
| Alkalinity Source | 10-80 | 20-60 | 40-60 | 40-50 |
| Oxygen source | 1-40 | 5-30 | 10-20 | 12-18 |
| Bleach activator | 0.0001-10 | 0.001-5 | 0.01-0.5 | 0.02-0.03 |
| Enzyme | 0.001-15 | 0.01-10 | 0.2-2 | 0.1-1.5 |
| Nonionic Surfactant(s) | 0.01-50 | 0.5-20 | 1-10 | 2-6 |
| Chelant(s) | 10-70 | 15-60 | 25-45 | 35-40 |
| Corrosion Inhibitor | 0.0001-10 | 0.001-5 | 0.01-2 | 0.2-0.4 |
| Additional Functional | 0-80 | 0-60 | 0-25 | 0-11 |
| Ingredients | | | | |

TABLE 2

| | Example | Example | Example | Example |
|---|---|---|---|---|
| | Range 1 | Range 2 | Range 3 | Range 4 |
| Formulations | (wt. %) | (wt. %) | (wt. %) | (wt. %) |
| Alkalinity | 10-80 | 20-60 | 40-60 | 40-50 |
| Source | | | | |
| Phosphate | 5-50 | 10-40 | 15-30 | 20-25 |
| Amino- | 0.5-45 | 1-35 | 5-25 | 10-15 |
| carboxylate | | | | |
| Secondary | 0.01-20 | 0.1-15 | 0.5-8 | 1-3 |
| Amino- | | | | |
| carboxylate | | | | |
| Corrosion | 0.0001-10 | 0.001-5 | 0.01-1 | 0.1-0.4 |
| Inhibitor | | | | |
| Peroxygen | 1-40 | 5-30 | 10-25 | 12-18 |
| Bleach | | | | |
| Bleach | 0.0001-5 | 0.0001-1 | 0.001-0.1 | 0.01-0.04 |
| activator | | | | |
| Enzyme | 0.0001-10 | 0.001-5 | 0.01-2 | 0.1-1.5 |
| Nonionic | 0.01-50 | 0.5-20 | 1-10 | 2-6 |
| Surfactant(s) | | | | |
| Additional | 0-85 | 0-65 | 0-30 | 0-20 |
| Functional | | | | |
| Ingredients | | | | |

Alkalinity Source According to an embodiment, the detergent compositions include one or more alkalinity sources. Exemplary alkalinity sources include alkali metal carbonates and/or alkali metal hydroxides. In a preferred embodiment, the compositions include dense ash or light ash. In a further preferred embodiment, the source of alkalinity comprises sodium carbonate.

Alkali metal carbonates used in the formulation of detergents are often referred to as ash-based detergents and most often employ sodium carbonate. Additional alkali metal carbonates include, for example, sodium or potassium carbonate. In an aspect, the alkali metal carbonates are further understood to include metasilicates, silicates, bicarbonates and sesquicarbonates. As described herein, any “ash-based” or “alkali metal carbonate” shall also be understood to include all alkali metal carbonates, metasilicates, silicates, bicarbonates and/or sesquicarbonates.

Alkali metal hydroxides used in the formulation of detergents are often referred to as caustic detergents. Examples of suitable alkali metal hydroxides include sodium hydroxide, potassium hydroxide, and lithium hydroxide. Exemplary alkali metal salts include sodium carbonate, potassium carbonate, and mixtures thereof. The alkali metal hydroxides may be added to the composition in any form known in the art, including as solid beads, dissolved in an aqueous solution, or a combination thereof. Alkali metal hydroxides are commercially available as a solid in the form of prilled solids or beads having a mix of particle sizes ranging from about 12-100 U.S. mesh, or as an aqueous solution, as for example, as a 45% and a 50% by weight solution.

In some embodiments, the compositions include between about 10 wt. % to about 80 wt. % of an alkalinity source, preferably between about 20 wt. % to about 60 wt. %, more preferably between about 40 wt. % to about 60 wt. %, and still more preferably between about 40 wt. % to about 50 wt. % of the alkalinity source.

Activated Oxygen Bleach

According to an embodiment, the detergent compositions include one or more activated oxygen bleaches. As used herein, the term “activated oxygen bleach” refers to a composition comprising at least one oxygen source (also referred to as simply “bleach”) and/or at least one bleach activator. In an embodiment, the activated oxygen bleach comprises an oxygen source and a bleach activator.

Oxygen Sources/Bleaches

Suitable bleaches for use in the compositions and methods include, without limitation, oxygen-based bleaches. Suitable oxygen-based bleaches are the peroxygen bleaches, such as sodium perborate (tetra-or monohydrate), sodium percarbonate, hydrogen peroxide, and peracids. Preferably, the bleach does not include a non-oxygen based bleach, including for example, halogen bleaches. In this respect, the compositions can be free of non-oxygen-based bleaches including, in particular halogen-bleaches.

Peracids suitable for use can be a single species or mixture. Suitable peracids can be selected based on the desired end use and based upon compatibility with other components in the compositions and methods. Preferred peracids include those having a carbon chain length of C2 to C12. Suitable peracids can include those described in U.S. Pat. No. 8,846,107, entitled, “In Situ Generation of Peroxycarboxylic Acids at Alkaline pH, and Methods of Use Thereof,” which is expressly incorporated herein in its entirety by reference, including without limitation all drawings and chemical structures contained therein. Suitable peracids can include alkyl ester peroxycarboxylic acids, ester peroxycarboxylic acids, sulfoperoxycarboxylic acids, and others. Suitable alkyl ester peroxycarboxylic acids and ester peroxycarboxylic acids can include those described in U.S. Pat. No. 7,816,555 entitled “Peroxycarboxylic Acid Compositions with Reduced Odor,” hereby expressly incorporated herein in its entirety by reference, including without limitation all drawings and chemical structures contained therein. Suitable sulfoperoxycarboxylic acids can include those described in U.S. Pat. No. 8,809,392, entitled, “Sulfoperoxycarboxylic Acids, Their Preparation and Methods of Use as Bleaching and Antimicrobial Agents,” which is expressly incorporated herein in its entirety by reference, including without limitation all drawings and chemical structures contained therein.

Peroxygen bleaches suitable for use in the compositions include, without limitation, sodium perborate monohydrate, sodium perborate tetrahydrate, sodium pyrophosphate peroxyhydrate, urea peroxyhydrate, sodium percarbonate, sodium peroxide and mixtures thereof. Preferred peroxygen bleaching compounds are selected from the group consisting of perborate salts and percarbonate salts, including sodium perborate monohydrate, sodium percarbonate, sodium perborate tetrahydrate and mixtures thereof. In a preferred embodiment, the oxygen source comprises sodium percarbonate.

In some embodiments, the compositions include between about 1 wt. % to about 40 wt. % of an oxygen source, preferably between about 5 wt. % to about 30 wt. %, more preferably between about 10 wt. % to about 20 wt. %, and still more preferably between about 12 wt. % to about 18 wt. % of an oxygen source.

Bleach Activator

According to an embodiment, the detergent compositions include one or more bleach activators. Suitable bleach activators include, without limitation, peroxygen catalysts, bleach activators such as tetraacetyl ethylenediamine (TAED), sodium nonanoyloxybenzene sulphonate (SNOBS), glucose pentaacetate (GPA), tetraacetylmethylene diamine (TAMD), triacetyl cyanurate, sodium sulphonyl ethyl carbonic acid ester, sodium acetyloxybenzene and the mono long-chain acyl tetraacetyl glucoses as disclosed in WO 1991/10719, other activators such as choline sulphophenyl carbonate (CSPC), as disclosed in U.S. Pat. Nos. 4,751,015 and 4,818,426 can also be used. Suitable peroxygen bleach precursors include, without limitation, sodium pbenzoyloxy-benzene sulfonate, N,N,N,N-tetraacetyl ethylenediamine (TEAD), sodium nonanoyloxybenzene sulfonate (SNOBS) and choline sulfophenyl carbonate (CSPC).

In an embodiment, the compositions include a peroxidation catalyst that is an Mn or Fe catalyst. Mn and Fe peroxidation catalysts where the metal in the form of a complex beneficially increases the activity and stability of the complex. In particular in the case of Mn complexes, various ligands can help to increase the solubility of the metal. Accordingly, in a preferred embodiment the compositions include an Mn or Fe catalyst with ligands according to Formula (I):

[(LₚM_{q})ₙXᵣ]Yₛ (I)

wherein each L independently is an organic ligand containing at least three nitrogen atoms and/or at least two carboxyl groups that coordinate with the metal M; “M” is preferably a transition metal, most preferably Mn or Fe; each “X” independently is a coordinating or bridging group that is one of H₂O, OH⁻, SH⁻, HO₂⁻, O²⁻, O₂²⁻, S²⁻, F⁻, Cl⁻, Br, I⁻, NO₃⁻, NO₂⁻, SO₄²⁻, SO₃²⁻, PO₄³⁻, N₃⁻, CN⁻, NR₃, NCS⁻, RCN, RS⁻, RCO₂⁻, RO⁻, or

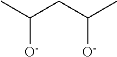

with R being hydrogen or a C₁ to C₆ alkyl group; “p” is an integer from 1 to 4; “q” is an integer from 1 to 2; “r” is an integer from 0 to 6; “Y” is a counter ion; and “s” is the number of counter ions.

In a further preferred embodiment, the peroxidation catalyst is a dinuclear complex according to Formula (II):

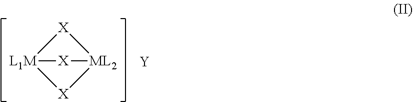

wherein L₁ and L₂ can either be separate ligands or where L₁ and L₂ can combine to be a single molecule. Any suitable bridging group may be used in the dinuclear complex of Formula (II), although the coordinating or bridging groups, the groups O²⁻, O₂²⁻, CH₃O—, CH₃CO²⁻,

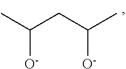

or Cl— are particularly preferred.

In an embodiment, the ligands may be triazacyclononane, triazacyclononane derivatives, Schiff-base containing ligands, polypyridineamine ligands, pentadentate nitrogen-donor ligands, bispidon-type ligands, or macrocyclic tetraamidate ligands. Examples for those classes of ligands are described by Ronald Hage & Achim Lienke, Applications of Transition Metal Catalysts to Textile and Wood-Pulp Bleaching, ANGEW. CHEM. INT. ED., 45(2) 206-222 (2006), which is herein incorporated by reference in its entirety.

In another embodiment, the ligands include dicarboxylates, for example oxalate. In a still further embodiment, the ligands may be compounds according to formulae (II) to (IV):

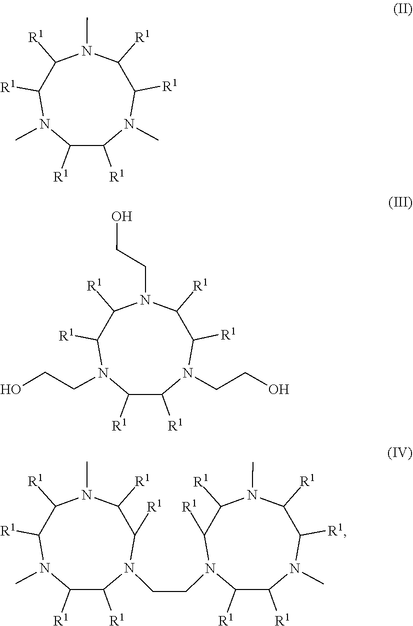

wherein each R¹ independently is hydrogen or a C₁ to C₆ alkyl group. Other suitable ligands are the compounds according to formulae (V) to (XVIII)

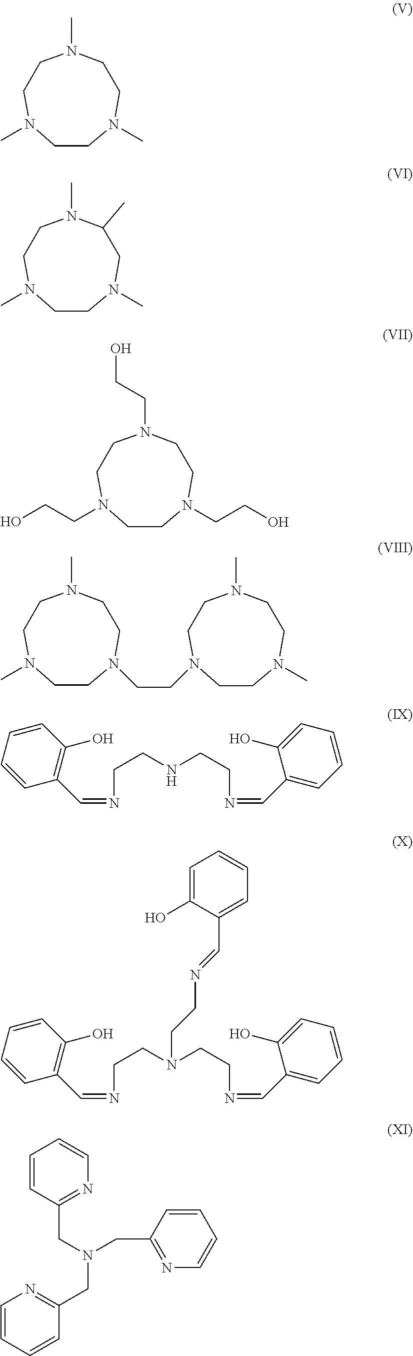

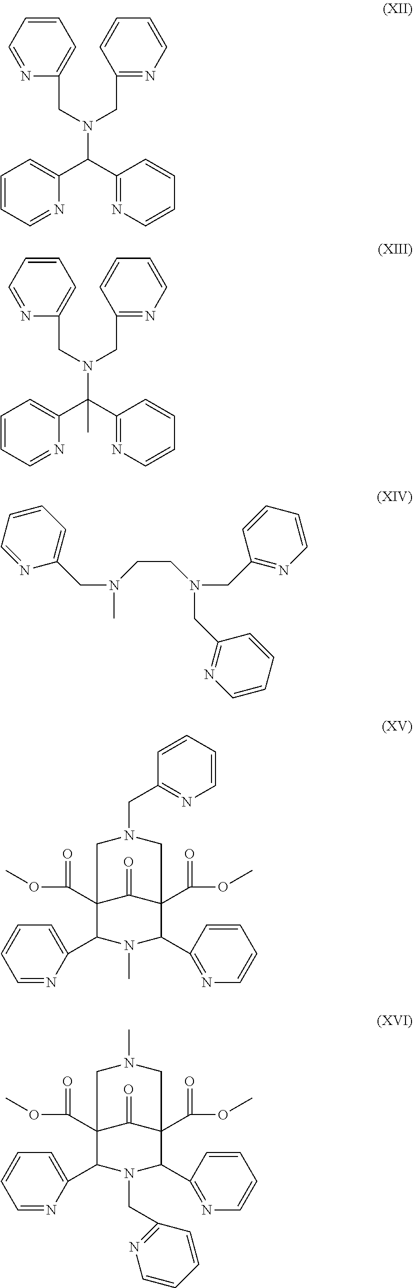

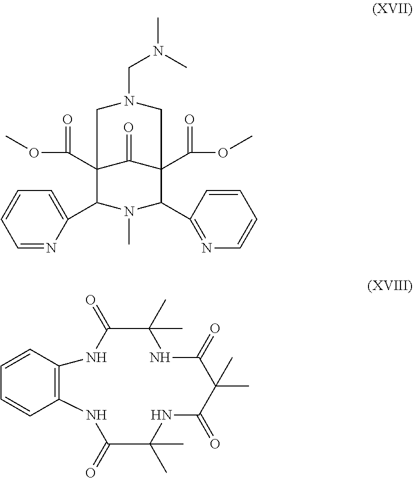

The ligands (V) to (X) are particularly suited if the metal M is Mn. The ligands (XII) to (XVIII) are particularly well-suited if the metal M is Fe. Ligand (XI) is equally suited for Mn and Fe.

The counter ion Y is selected depending on the charge of the complex [(LₚM_{q})ₙXᵣ]. The number of counter ions s is equal to the number of counter ions required to achieve charge neutrality. Preferably the number of counter ions s is 1 to 3. The type of counter ion Y for charge neutrality is not critical for the activity of the complex and can be selected from, for example, the group consisting of Cl⁻, Br, I⁻, NO₃⁻, ClO₄⁻, NCS⁻, BPh₄⁻, BF₄⁻, PF₆⁻, R²—SO₃⁻, R²—SO₄⁻, and R²—CO₂⁻, wherein R² is hydrogen or a C₁ to C₄ alkyl group. Particularly preferred counter ions are PF₆⁻ and ClO₄⁻.

In an embodiment, the peroxidation catalyst is a complex according to formula (II), wherein M is manganese, X is selected from the group consisting of O²⁻, O₂²⁻, CH₃O—, CH₃CO²⁻,

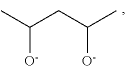

or Cl—, and the ligand L is a compound according to formulae (II) and/or (IV). In a preferred embodiment, M is manganese and L is oxalate.

Further suitable peroxidation catalysts include but are not limited to compounds according to formulae (XIX) and (XX), also referred to as MnTACN and MnDTNE, respectively.

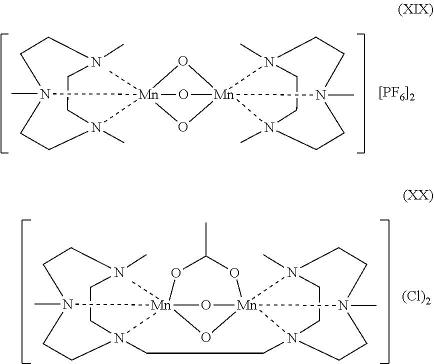

Where the peroxidation catalyst is a compound containing M, the detergent may comprise from about 0.0005% to about 0.12% by weight of the metal M in the form of a peroxidation catalyst complex, preferably from about 0.001% to about 0.05% by weight. Overall, the bleach activator may comprise from about 0.0001 wt. % to about 10 wt. % of the detergent compositions, preferably between about 0.001 wt. % to about 5 wt. %, more preferably between 0.01 wt. % to about 0.5 wt. %, and most preferably between 0.02 wt. % to about 0.03 wt. % of the detergent compositions.

Enzyme

In some embodiments the compositions may include one or more enzymes to provide synergistically improved removal of starch-based and other soils. Although not limiting to the present invention, enzymes suitable for the detergent composition can act by degrading or altering one or more types of soil residues encountered on crockery thus removing the soil or making the soil more removable by a surfactant or other component of the cleaning composition. In a preferred embodiment the enzyme is an amylase enzyme.

Exemplary amylase enzymes can be derived from a plant, an animal, or a microorganism. The amylase may be derived from a microorganism, such as yeast, mold, or bacterium. Exemplary amylases include those derived from a Bacillus, such as B. licheniformis, B. amyloliquefaciens, B. subtilis, or B. stearothermophilus. The amylase can be purified or a component of a microbial extract, and either wild type or variant (either chemical or recombinant).

Exemplary amylase enzymes include those sold under the trade name Rapidase by Gist-Brocades® (Netherlands); those sold under the trade names Termamyl®, Achieve Choice®, Fungamyl® or Duramyl® by Novozymes; those sold under the trade names Purastar STL or Purastar OXAM by Genencor; those sold under the trade names Thermozyme® L340 or Deterzyme® PAG 510/220 by Deerland Corporation; and the like. A mixture of amylases can also be used. In a preferred embodiment, the amylase is Termamyl 120T® or Achieve Choice 150T®.

The compositions may include enzymes in addition to one or more amylases. Additional suitable enzymes may include a protease, a lipase, a gluconase, a cellulase, a peroxidase, a catalase, or a mixture thereof of any suitable origin, such as vegetable, animal, bacterial, fungal or yeast origin.

Examples of proteolytic enzymes which can be employed in the detergent composition of the invention include (with trade names) Savinase®, a protease derived from Bacillus lentus type, such as Maxacal®, Opticlean®, Durazym®, and Properase®; a protease derived from Bacillus licheniformis, such as Alcalase®, Maxatase®, Deterzyme®, or Deterzyme PAG 510/220; a protease derived from Bacillus amyloliquefaciens, such as Primase®; and a protease derived from Bacillus alcalophilus, such as Deterzyme APY. Exemplary commercially available protease enzymes include those sold under the trade names Alcalase®, Savinase®, Primase®, Durazym®, Blaze® (e.g., Blaze® Exceed, Blaze® Evity®), or Esperase® by Novo Industries A/S (Denmark); those sold under the trade names Maxatase®, Maxacal®, or Maxapem® by Gist-Brocades (Netherlands); those sold under the trade names Purafect®, Purafect OX, and Properase by Genencor International; those sold under the trade names Opticlean® or Optimase® by Solvay Enzymes; those sold under the tradenames Deterzyme®, Deterzyme APY, and Deterzyme PAG 510/220 by Deerland Corporation, and the like.

Exemplary cellulase enzymes can be derived from a plant, an animal, or a microorganism, such as a fungus or a bacterium. Cellulases derived from a fungus include the fungus Humicola insolens, Humicola strain DSM1800, or a cellulase 212-producing fungus belonging to the genus Aeromonas and those extracted from the hepatopancreas of a marine mollusk, Dolabella Auricula Solander. The cellulase can be purified or a component of an extract, and either wild type or variant (either chemical or recombinant). Examples of cellulase enzymes include those sold under the trade names Carezyme® or Celluzyme® by Novo; under the tradename Cellulase by Genencor; under the tradename Deerland Cellulase 4000 or Deerland Cellulase TR by Deerland Corporation; and the like. A mixture of cellulases can also be used.

Exemplary lipase enzymes can be derived from a plant, an animal, or a microorganism, such as a fungus or a bacterium. Exemplary lipases include those derived from a Pseudomonas, such as Pseudomonas stutzeri ATCC 19.154, or from a Humicola, such as Humicola lanuginosa (typically produced recombinantly in Aspergillus oryzae). The lipase can be purified or a component of an extract, and either wild type or variant (either chemical or recombinant). Exemplary lipase enzymes include those sold under the trade names Lipase P “Amano” or “Amano-P” by Amano Pharmaceutical Co. Ltd., Nagoya, Japan or under the trade name Lipolase® by Novo, and the like. Other commercially available lipases include Amano-CES, lipases derived from Chromobacter viscosum, e.g. Chromobacter viscosum var. lipolyticum NRRLB 3673 from Toyo Jozo Co., Tagata, Japan; Chromobacter viscosum lipases from U.S. Biochemical Corp., U.S.A. and Disoynth Co., and lipases derived from Pseudomonas gladioli or from Humicola lanuginosa. A preferred lipase is sold under the trade name Lipolase® by Novo. A mixture of lipases can also be used.

Additional suitable enzymes include a cutinase, a peroxidase, a gluconase, and the like. Exemplary cutinase enzymes are described in WO 88/09367A, which is herein incorporated by reference in its entirety. Exemplary peroxidases include horseradish peroxidase, ligninase, and haloperoxidases such as chloro- or bromo-peroxidase. Exemplary peroxidases are also disclosed in WO 89/09813A, which is herein incorporated by reference in its entirety. These additional enzymes can be derived from a plant, an animal, or a microorganism. The enzyme can be purified or a component of an extract, and either wild type or variant (either chemical or recombinant). Mixtures of different additional enzymes can be used.

Regardless of the type of enzyme(s) utilized, the form of the enzyme may vary based on availability or form of the composition. For example, the enzyme(s) may be provided as a liquid, solid, granule, encapsulated liquid, encapsulated solid, and/or as part of an enzyme-catalyst complex or package. For example, a granulated protease enzyme may be provided together with granulated a manganese-based catalyst to enhance performance and ease of use.

Enzymes, particularly an amylase enzyme may be present in the detergent compositions in an amount of between about 0.0001 wt. % to about 10 wt. %, preferably between about 0.001 wt. % to about 5 wt. %, more preferably between about 0.01 wt. % to about 2 wt. %, most preferably between about 0.1 wt. % to about 1.5 wt. % of the detergent composition.

Chelants, Sequestrants, Water Conditioning Agents

The composition can include one or more water conditioning agents or building agents, also called chelating or sequestering agents (e.g., builders), including, but not limited to: condensed phosphates, alkali metal carbonates, phosphonates, aminocarboxylic acids, polycarboxylic acids, polycarboxylic acid polymers, and/or polyacrylates. In general, a chelating agent is a molecule capable of coordinating (i.e., binding) the metal ions commonly found in natural water to prevent the metal ions from interfering with the action of the other detersive ingredients of a cleaning composition. Similarly, builders and water conditioning agents also aid in removing metal compounds. Exemplary water conditioning agents include anti-redeposition agents, chelating agents, sequestering agents and inhibitors.

Examples of condensed phosphates include but are not limited to sodium and potassium orthophosphate, sodium and potassium pyrophosphate, sodium tripolyphosphate, and sodium hexametaphosphate. A condensed phosphate may also assist, to a limited extent, in solidification of the composition by fixing the free water present in the composition as water of hydration.

Examples of phosphonates include, but are not limited to: 2-phosphinobutane-1,2,4-tricarboxylic acid (PBTC), 1-hydroxyethane-1, 1-diphosphonic acid, CH₂C(OH)[PO(OH)₂]₂; aminotri(methylenephosphonic acid), N[CH₂PO(OH)₂]₃; aminotri(methylenephosphonate), sodium salt (ATMP), N[CH₂PO(ONa)₂]₃; 2-hydroxyethyliminobis(methylenephosphonic acid), HOCH₂CH₂N[CH₂PO(OH)₂]₂; diethylenetriaminepenta(methylenephosphonic acid), (HO)₂POCH₂N[CH₂N[CH₂PO(OH)₂]₂]₂; diethylenetriaminepenta(methylenephosphonate), sodium salt (DTPMP), C₉H₍₂₈₋ₓ₎ N₃NaₓO₁₅P₅ (x=7); hexamethylenediamine(tetramethylenephosphonate), potassium salt, C₁₀H₍₂₈₋ₓ₎ N₂Kₓ O₁₂P₄ (x=6); bis(hexamethylene)triamine(pentamethylenephosphonic acid), (HO₂)POCH₂ N[(CH₂)₂N[CH₂PO(OH)₂]₂]₂; and phosphorus acid, H₃PO₃. Preferred phosphonates are PBTC, HEDP, ATMP and DTPMP. A neutralized or alkali phosphonate, or a combination of the phosphonate with an alkali source prior to being added into the mixture such that there is little, or no heat or gas generated by a neutralization reaction when the phosphonate is added is preferred. In one embodiment, however, the composition is phosphorous-free.

Useful aminocarboxylic acid materials containing little or no NTA include, but are not limited to: N-hydroxyethylaminodiacetic acid, ethylenediaminetetraacetic acid (EDTA), hydroxyethylenediaminetetraacetic acid, diethylenetriaminepentaacetic acid, N-hydroxyethyl-ethylenediaminetriacetic acid (HEDTA), diethylenetriaminepentaacetic acid (DTPA), methylglycinediacetic acid (MGDA), glutamic acid-N,N-diacetic acid (GLDA), ethylenediaminesuccinic acid (EDDS), 2-hydroxyethyliminodiacetic acid (HEIDA), iminodisuccinic acid (IDS), 3-hydroxy-2-2′-iminodisuccinic acid (HIDS) and other similar acids or salts thereof having an amino group with a carboxylic acid substituent. In one embodiment, however, the composition is free of aminocarboxylates.

Suitable organic water conditioning agents can include both polymeric and small molecule water conditioning agents. Organic small molecule water conditioning agents are typically organocarboxylate compounds or organophosphate water conditioning agents. Polymeric inhibitors commonly comprise polyanionic compositions such as polyacrylic acid compounds. More recently the use of sodium carboxymethyl cellulose as an antiredeposition agent was discovered. This is discussed more extensively in U.S. Pat. No. 8,729,006 to Miralles et al., which is incorporated herein in its entirety.

Small molecule organic water conditioning agents include, but are not limited to: sodium gluconate, sodium glucoheptonate, N-hydroxyethylenediaminetriacetic acid (HEDTA), ethylenediaminetetraacetic acid (EDTA), nitrilotriacetic acid (NTA), diethylenetriaminepentaacetic acid (DTPA), ethylenediaminetetraproprionic acid, triethylenetetraaminehexaacetic acid (TTHA), and the respective alkali metal, ammonium and substituted ammonium salts thereof, ethylenediaminetetraacetic acid tetrasodium salt (EDTA), nitrilotriacetic acid trisodium salt (NTA), ethanoldiglycine disodium salt (EDG), diethanolglycine sodium-salt (DEG), and 1,3-propylenediaminetetraacetic acid (PDTA), dicarboxymethyl glutamic acid tetrasodium salt (GLDA), methylglycine-N—N-diacetic acid trisodium salt (MGDA), and iminodisuccinate sodium salt (IDS). All of these are known and commercially available.

Suitable inorganic water conditioning agents include, but are not limited to, sodium tripolyphosphate and other higher linear and cyclic polyphosphates species. Suitable condensed phosphates include alkali metal phosphates such as sodium and potassium orthophosphate, sodium and potassium pyrophosphate, sodium tripolyphosphate, and sodium hexametaphosphate. A condensed phosphate may also assist, to a limited extent, in solidification of the solid detergent composition by fixing the free water present in the composition as water of hydration.

In an embodiment, the composition can be substantially free of phosphorous, phosphates and/or phosphonates.

In addition to aminocarboxylates, which contain little or no NTA, water conditioning polymers can be used as non-phosphorous containing builders. Polycarboxylic acid polymer chelants are non-phosphorus containing chelants. Polycarboxylates include those chelant polymers having pendant carboxylate (—CO2-) groups such as polyacrylic acid homopolymers, polymaleic acid homopolymers, maleic/olefin copolymers, sulfonated copolymers or terpolymers, acrylic/maleic copolymers or terpolymers polymethacrylic acid homopolymers, polymethacrylic acid copolymers or terpolymers, acrylic acid-methacrylic acid copolymers, hydrolyzed polyacrylamides, hydrolyzed polymethacrylamides, hydrolyzed polyamide-methacrylamide copolymers, hydrolyzed polyacrylonitriles, hydrolyzed polymethacrylonitriles, hydrolyzed acrylonitrile-methacrylonitrile copolymers and combinations thereof. For a further discussion of chelating agents/sequestrants, see Kirk-Othmer, Encyclopedia of Chemical Technology, Third Edition, volume 5, pages 339-366 and volume 23, pages 319-320, the disclosure of which is incorporated by reference herein. These materials may also be used at sub-stoichiometric levels to function as crystal modifiers.

Polycarboxylic acid polymer chelants can include polyacrylic acid homopolymers and polymaleic acid homopolymers, and polymers modified by a fatty acid end group. Exemplary polyacrylic acid homopolymers include those with a molecular weight between about 500-100,000 g/mol, or between about 1,000-50,000 g/mol, or between about 1,000-25,000 g/mol. Exemplary suitable commercially available polyacrylic acid polymers include Acusol 445N (a fully neutralized homopolymer of acrylic acid), Acusol 448 and Acusol 944 available from Dow Chemical. Exemplary suitable commercially available polymaleic acid chelants/water conditioners include, for example, Belclene 200, commercially available from BWA.

In additional embodiments, mixtures of acrylic acid homopolymers and/or polymers including acrylate monomers can be employed.

In an embodiment, the one or more chelants/sequestrants/water conditioning agents comprise a phosphate and one or more aminocarboxylates. In a still further embodiment, the phosphate is sodium tripolyphosphate and the one or more aminocarboxylate are MGDA and GLDA.

In some embodiments, the detergent compositions include one or more chelants, present in an amount of between about 10 wt. % to about 70 wt. %, preferably between about 15 wt. % to about 60 wt. %, more preferably between about 25 wt. % to about 45 wt. %, most preferably between about 35 wt. % to about 40 wt. % of the composition. In an embodiment, the one or more chelants/sequestrants/water conditioning agents includes a phosphate, an aminocarboxylate, and a phosphonate. In an embodiment comprising a phosphate and one or more aminocarboxylates, wherein the composition includes between about 5 wt. % to about 50 wt. % of a phosphate, preferably between about 10 wt. % to about 40 wt. %, more preferably between about 15 wt. % to about 30 wt. %, most preferably between about 20 wt. % to about 25 wt. %; between about 0.5 wt. % to about 45 wt. % of an aminocarboxylate, preferably between about 1 wt. % to about 35 wt. %, more preferably between about 5 wt. % to about 25 wt. %, most preferably between about 10 wt. % to about 15 wt. %; and between about 0.01 wt. % to about 20 wt. % of a secondary aminocarboxylate, preferably between 0.1 wt. % to about 15 wt. %, more preferably between about 0.5 wt. % to about 8 wt. %, most preferably between about 1 wt. % to about 3 wt. % of the detergent composition.

Surfactants

In some embodiments, the detergent compositions described herein include one or more surfactants. Surfactants suitable for use include, but are not limited to, nonionic surfactants, anionic surfactants, cationic surfactants, amphoteric surfactants and/or zwitterionic surfactants. In a preferred embodiment, the compositions include one or more nonionic surfactants. In a further preferred embodiment, the one or more nonionic surfactants include a nonionic polyoxyethylene-polyoxypropylene (EO/PO) block copolymer. In a still further preferred embodiment, the EO/PO block copolymer is a poloxamer (EO/PO/EO).

In some embodiments, the detergent compositions include between about 0.01 wt. % to about 50 wt. % of one or more surfactants, including, for example, about 0.01 wt. %, 5 wt. %, 10 wt. %, 20 wt. %, 30 wt. %, 40 wt. %, and 50 wt. % of one or more nonionic, anionic, cationic, amphoteric, and/or zwitterionic surfactants. In an embodiment, the detergent compositions include one or more nonionic surfactants present in amounts of between about 0.01 wt. % to about 50 wt. %, preferably between about 0.5 wt. % to about 20 wt. %, more preferably between 1 wt. % to about 10 wt. %, most preferably between about 2 wt. % to about 6 wt. %.

Nonionic Surfactants

Suitable nonionic surfactants suitable for use include, for example, alkoxylated surfactants. Suitable alkoxylated surfactants include EO/PO copolymers, capped EO/PO copolymers, alcohol alkoxylates, capped alcohol alkoxylates, mixtures thereof, or the like. Suitable alkoxylated surfactants for use as solvents include EO/PO block copolymers, such as the Pluronic® and reverse Pluronic® surfactants; alcohol alkoxylates; capped alcohol alkoxylates; mixtures thereof, or the like.

Useful nonionic surfactants are generally characterized by the presence of an organic hydrophobic group and an organic hydrophilic group and are typically produced by the condensation of an organic aliphatic, alkyl aromatic or polyoxyalkylene hydrophobic compound with a hydrophilic alkaline oxide moiety which in common practice is ethylene oxide or a polyhydration product thereof, polyethylene glycol. Practically any hydrophobic compound having a hydroxyl, carboxyl, amino, or amido group with a reactive hydrogen atom can be condensed with ethylene oxide, or its polyhydration adducts, or its mixtures with alkoxylenes such as propylene oxide to form a nonionic surface-active agent. The length of the hydrophilic polyoxyalkylene moiety which is condensed with any particular hydrophobic compound can be readily adjusted to yield a water dispersible or water-soluble compound having the desired degree of balance between hydrophilic and hydrophobic properties.

Block polyoxypropylene-polyoxyethylene polymeric compounds based upon propylene glycol, ethylene glycol, glycerol, trimethylolpropane, and ethylenediamine as the initiator reactive hydrogen compound are suitable nonionic surfactants.

Some examples of polyoxyethylene-polyoxypropylene block copolymers include those having the following formulae:

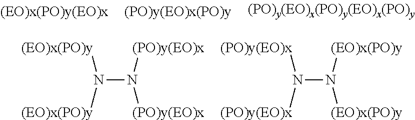

wherein EO represents an ethylene oxide group, PO represents a propylene oxide group, and x and y reflect the average molecular proportion of each alkylene oxide monomer in the overall block copolymer composition. In some embodiments, x is in the range of about 10 to about 130, y is in the range of about 15 to about 70, and x plus y is in the range of about 25 to about 200. It should be understood that each x and y in a molecule can be different. In some embodiments, the total polyoxyethylene component of the block copolymer can be in the range of at least about 20 mol-% of the block copolymer and in some embodiments, in the range of at least about 30 mol-% of the block copolymer. In some embodiments, the material can have a molecular weight greater than about 400, and in some embodiments, greater than about 500. For example, in some embodiments, the material can have a molecular weight in the range of about 500 to about 7000 or more, or in the range of about 950 to about 4000 or more, or in the range of about 1000 to about 3100 or more, or in the range of about 2100 to about 6700 or more.

Although the exemplary polyoxyethylene-polyoxypropylene block copolymer structures provided above have 3-8 blocks, it should be appreciated that the nonionic block copolymer surfactants can include more or less than 3 or 8 blocks. In addition, the nonionic block copolymer surfactants can include additional repeating units such as butylene oxide repeating units. Furthermore, suitable nonionic block copolymer surfactants can be characterized as heteric polyoxyethylene-polyoxypropylene block copolymers. Examples of polymeric compounds made from a sequential propoxylation and ethoxylation of initiator are commercially available under the trade names Pluronic® and Tetronic® manufactured by BASF Corp, in particular Pluronic® N-3, Pluronic® 25-R2, and others.

For example, suitable nonionic surfactants may include without limitation poloxamers (EO/PO/EO) available under the trade names Adeka 25R1®, Adeka 25R2®, Adeka L61®, Adeka F108®, Antarox 17R4®, Antarox 25R2®, Antarox B25®, and Antrarox F108®.

Pluronic® compounds are difunctional (two reactive hydrogens) compounds formed by condensing ethylene oxide with a hydrophobic base formed by the addition of propylene oxide to the two hydroxyl groups of propylene glycol. This hydrophobic portion of the molecule weighs from about 1,000 to about 4,000. Ethylene oxide is then added to sandwich this hydrophobe between hydrophilic groups, controlled by length to constitute from about 10% by weight to about 80% by weight of the final molecule.

Tetronic® compounds are tetra-functional block copolymers derived from the sequential addition of propylene oxide and ethylene oxide to ethylenediamine. The molecular weight of the propylene oxide hydrotype ranges from about 500 to about 7,000; and, the hydrophile, ethylene oxide, is added to constitute from about 10% by weight to about 80% by weight of the molecule.

Semi-Polar Nonionic Surfactants

The semi-polar type of nonionic surface-active agents are another class of nonionic surfactant which may be useful in the detergent compositions described herein. Semi-polar nonionic surfactants include the amine oxides, phosphine oxides, sulfoxides and their alkoxylated derivatives.

Amine oxides are tertiary amine oxides corresponding to the general formula:

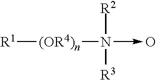

wherein the arrow is a conventional representation of a semi-polar bond; and, R¹, R², and R³ may be aliphatic, aromatic, heterocyclic, alicyclic, or combinations thereof. Generally, for amine oxides of detergent interest, R¹ is an alkyl radical of from about 8 to about 24 carbon atoms; R² and R³ are alkyl or hydroxyalkyl of 1-3 carbon atoms or a mixture thereof; R² and R³ can be attached to each other, e.g. through an oxygen or nitrogen atom, to form a ring structure; R⁴ is an alkylene or a hydroxyalkylene group containing 2 to 3 carbon atoms; and n ranges from 0 to about 20. An amine oxide can be generated from the corresponding amine and an oxidizing agent, such as hydrogen peroxide.

Useful semi-polar nonionic surfactants also include the water-soluble phosphine oxides having the following structure:

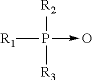

wherein the arrow is a conventional representation of a semi-polar bond; and, R¹ is an alkyl, alkenyl or hydroxyalkyl moiety ranging from 10 to about 24 carbon atoms in chain length; and, R² and R³ are each alkyl moieties separately selected from alkyl or hydroxyalkyl groups containing 1 to 3 carbon atoms.

Examples of useful phosphine oxides include dimethyldecylphosphine oxide, dimethyltetradecylphosphine oxide, methylethyltetradecylphosphone oxide, dimethylhexadecylphosphine oxide, diethyl-2-hydroxyoctyldecylphosphine oxide, bis(2-hydroxyethyl) dodecylphosphine oxide, and bis(hydroxymethyl)tetradecylphosphine oxide. Useful water soluble amine oxide surfactants are selected from the octyl, decyl, dodecyl, isododecyl, coconut, or tallow alkyl di-(lower alkyl) amine oxides, specific examples of which are octyldimethylamine oxide, nonyldimethylamine oxide, decyldimethylamine oxide, undecyldimethylamine oxide, dodecyldimethylamine oxide, iso-dodecyldimethyl amine oxide, tridecyldimethylamine oxide, tetradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl)dodecylamine oxide, bis(2-hydroxyethyl)-3-dodecoxy-1-hydroxypropylamine oxide, dimethyl-(2-hydroxydodecyl)amine oxide, 3,6,9-trioctadecyldimethylamine oxide and 3-dodecoxy-2-hydroxypropyldi-(2-hydroxyethyl)amine oxide.

Semi-polar nonionic surfactants useful herein also include the water-soluble sulfoxide compounds which have the structure:

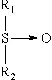

wherein the arrow is a conventional representation of a semi-polar bond; and, R¹ is an alkyl or hydroxyalkyl moiety of about 8 to about 28 carbon atoms, from 0 to about 5 ether linkages and from 0 to about 2 hydroxyl substituents; and R² is an alkyl moiety consisting of alkyl and hydroxyalkyl groups having 1 to 3 carbon atoms. Useful examples of these sulfoxides include dodecyl methyl sulfoxide; 3-hydroxy tridecyl methyl sulfoxide; 3-methoxy tridecyl methyl sulfoxide; and 3-hydroxy-4-dodecoxybutyl methyl sulfoxide.

Suitable semi-polar nonionic surfactants include, without limitation, dimethyl amine oxides, such as lauryl dimethyl amine oxide, myristyl dimethyl amine oxide, cetyl dimethyl amine oxide, combinations thereof, and the like. Alkoxylated amines or, most particularly, alcohol alkoxylated/aminated/alkoxylated surfactants are also suitable. These non-ionic surfactants may be at least in part represented by the general formulae: R²⁰—(PO)_{S}N-(EO)ₜH, R²⁰—(PO)_{S}N-(EO)ₜH(EO)ₜH, and R²⁰—N(EO)ₜH; in which R²⁰ is an alkyl, alkenyl or other aliphatic group, or an alkyl-aryl group of from 8 to 20, preferably 12 to 14 carbon atoms, EO is oxyethylene, PO is oxypropylene, s is 1 to 20, preferably 2-5, t is 1-10, preferably 2-5, and u is 1-10, preferably 2-5. Other variations on the scope of these compounds may be represented by the alternative formula: R²⁰—(PO)_{V}—N[(EO)_{w}H][(EO)_{z}H] in which R²⁰ is as defined above, v is 1 to 20 (e.g., 1, 2, 3, or 4 (preferably 2)), and w and z are independently 1-10, preferably 2-5. These compounds are represented commercially by a line of products sold by Huntsman Chemicals as nonionic surfactants.

Anionic Surfactants

Anionic sulfate surfactants suitable for use in the present compositions include alkyl ether sulfates, alkyl sulfates, the linear and branched primary and secondary alkyl sulfates, alkyl ethoxysulfates, fatty oleyl glycerol sulfates, alkyl phenol ethylene oxide ether sulfates, the C₅-C₁₇ acyl-N—(C₁-C₄ alkyl) and —N—(C₁-C₂ hydroxyalkyl) glucamine sulfates, and sulfates of alkylpolysaccharides such as the sulfates of alkylpolyglucoside, and the like. Also included are the alkyl sulfates, alkyl poly(ethyleneoxy) ether sulfates and aromatic poly(ethyleneoxy) sulfates such as the sulfates or condensation products of ethylene oxide and nonyl phenol (usually having 1 to 6 oxyethylene groups per molecule).

Anionic sulfonate surfactants suitable for use in the present compositions also include alkyl sulfonates, the linear and branched primary and secondary alkyl sulfonates, and the aromatic sulfonates with or without substituents.

Anionic carboxylate surfactants suitable for use in the present compositions include carboxylic acids (and salts), such as alkanoic acids (and alkanoates), ester carboxylic acids (e.g. alkyl succinates), ether carboxylic acids, and the like. Such carboxylates include alkyl ethoxy carboxylates, alkyl aryl ethoxy carboxylates, alkyl polyethoxy polycarboxylate surfactants and soaps (e.g. alkyl carboxyls). Secondary carboxylates useful in the present compositions include those which contain a carboxyl unit connected to a secondary carbon. The secondary carbon can be in a ring structure, e.g. as in p-octyl benzoic acid, or as in alkyl-substituted cyclohexyl carboxylates. The secondary carboxylate surfactants typically contain no ether linkages, no ester linkages and no hydroxyl groups. Further, they typically lack nitrogen atoms in the head-group (amphiphilic portion). Suitable secondary soap surfactants typically contain 11-13 total carbon atoms, although more carbons atoms (e.g., up to 16) can be present. Suitable carboxylates also include acylamino acids (and salts), such as acylgluamates, acyl peptides, sarcosinates (e.g. N-acyl sarcosinates), taurates (e.g. N-acyl taurates and fatty acid amides of methyl tauride), and the like.

Suitable anionic surfactants include alkyl or alkylaryl ethoxy carboxylates of the following formula:

R—O—(CH₂CH₂O)ₙ(CH₂)ₘ—CO₂X (3)

in which R is a C₈ to C₂₂ alkyl group or

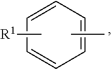

in which R¹ is a C₄-C₁₆ alkyl group;

n is an integer of 1-20; m is an integer of 1-3; and X is a counter ion, such as hydrogen, sodium, potassium, lithium, ammonium, or an amine salt such as monoethanolamine, diethanolamine or triethanolamine. In some embodiments, n is an integer of 4 to 10 and m is 1. In some embodiments, R is a C5-C16 alkyl group. In some embodiments, R is a C12-C14 alkyl group, n is 4, and m is 1.

In other embodiments, R is

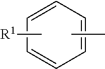

and R¹ is a C6-C12 alkyl group. In still yet other embodiments, R¹ is a C9 alkyl group, n is 10 and m is 1.

Such alkyl and alkylaryl ethoxy carboxylates are commercially available. These ethoxy carboxylates are typically available as the acid forms, which can be readily converted to the anionic or salt form. Commercially available carboxylates include, Neodox 23-4, a C12-13 alkyl polyethoxy (4) carboxylic acid (Shell Chemical), and Emcol CNP-110, a C9 alkylaryl polyethoxy (10) carboxylic acid (Witco Chemical). Carboxylates are also available from Clariant, e.g. the product Sandopan® DTC, a C13 alkyl polyethoxy (7) carboxylic acid.

Amphoteric Surfactants

Amphoteric, or ampholytic, surfactants contain both a basic and an acidic hydrophilic group and an organic hydrophobic group. These ionic entities may be any of anionic or cationic groups described herein for other types of surfactants. A basic nitrogen and an acidic carboxylate group are the typical functional groups employed as the basic and acidic hydrophilic groups. In a few surfactants, sulfonate, sulfate, phosphonate or phosphate provide the negative charge.

Amphoteric surfactants can be broadly described as derivatives of aliphatic secondary and tertiary amines, in which the aliphatic radical may be straight chain or branched and wherein one of the aliphatic substituents contains from about 8 to 18 carbon atoms and one contains an anionic water solubilizing group, e.g., carboxy, sulfo, sulfato, phosphato, or phosphino. Amphoteric surfactants are subdivided into two major classes known to those of skill in the art and described in “Surfactant Encyclopedia” Cosmetics & Toiletries, Vol. 104 (2) 69-71 (1989), which is herein incorporated by reference in its entirety. The first class includes acyl/dialkyl ethylenediamine derivatives (e.g. 2-alkyl hydroxyethyl imidazoline derivatives) and their salts. The second class includes N-alkylamino acids and their salts. Some amphoteric surfactants can be envisioned as fitting into both classes.

Amphoteric surfactants can be synthesized by methods known to those of skill in the art. For example, 2-alkyl hydroxyethyl imidazoline is synthesized by condensation and ring closure of a long chain carboxylic acid (or a derivative) with dialkyl ethylenediamine. Commercial amphoteric surfactants are derivatized by subsequent hydrolysis and ring-opening of the imidazoline ring by alkylation—for example with chloroacetic acid or ethyl acetate. During alkylation, one or two carboxy-alkyl groups react to form a tertiary amine and an ether linkage with differing alkylating agents yielding different tertiary amines.

Suitable long chain imidazole derivatives may generally have the general formula:

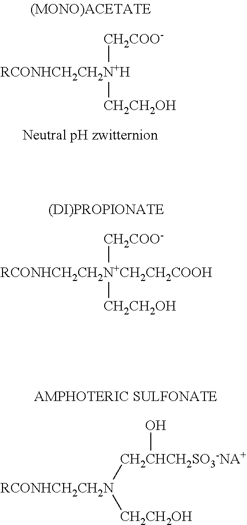

wherein R is an acyclic hydrophobic group containing from about 8 to 18 carbon atoms and M is a cation to neutralize the charge of the anion, generally sodium. Commercially prominent imidazoline-derived amphoterics that can be employed in the present compositions include for example: cocoamphopropionate, cocoamphocarboxy-propionate, cocoamphoglycinate, cocoamphocarboxy-glycinate, cocoamphopropyl-sulfonate, and cocoamphocarboxy-propionic acid. Amphocarboxylic acids can be produced from fatty imidazolines in which the dicarboxylic acid functionality of the amphodicarboxylic acid is diacetic acid and/or dipropionic acid.

The carboxymethylated compounds (glycinates) described herein above frequently are called betaines. Betaines are a special class of amphoteric discussed herein below in the section entitled, Zwitterion Surfactants.

Long chain N-alkylamino acids are readily prepared by reaction RNH₂, in which R═C₈-C₁₈ straight or branched chain alkyl, fatty amines with halogenated carboxylic acids. Alkylation of the primary amino groups of an amino acid leads to secondary and tertiary amines. Alkyl substituents may have additional amino groups that provide more than one reactive nitrogen center. Most commercial N-alkylamine acids are alkyl derivatives of beta-alanine or beta-N(2-carboxyethyl) alanine. Examples of commercial N-alkylamino acid ampholytes which are suitable include, without limitation, alkyl beta-amino dipropionates, RN(C₂H₄COOM)₂ and RNHC₂H₄COOM. In an embodiment, R can be an acyclic hydrophobic group containing from about 8 to about 18 carbon atoms, and M is a cation to neutralize the charge of the anion.

Suitable amphoteric surfactants include those derived from coconut products such as coconut oil or coconut fatty acid. Additional suitable coconut derived surfactants include as part of their structure an ethylenediamine moiety, an alkanolamide moiety, an amino acid moiety, e.g., glycine, or a combination thereof; and an aliphatic substituent of from about 8 to 18 (e.g., 12) carbon atoms. Such a surfactant can also be considered an alkyl amphodicarboxylic acid. These amphoteric surfactants can include chemical structures represented as: C₁₂-alkyl-C(O)—NH—CH₂—CH₂—N⁺(CH₂—CH₂—CO₂Na)₂—CH₂—CH₂—OH or C₁₂-alkyl-C(O)—N(H)—CH₂—CH₂—N⁺(CH₂—CO₂Na)₂—CH₂—CH₂—OH. Disodium cocoampho dipropionate is one suitable amphoteric surfactant and is commercially available under the tradename Miranol™ FBS from Rhodia Inc., Cranbury, N.J. Another suitable coconut derived amphoteric surfactant with the chemical name disodium cocoampho diacetate is sold under the tradename Mirataine™ JCHA, also from Rhodia Inc., Cranbury, N.J. A typical listing of amphoteric classes, and species of these surfactants, is given in U.S. Pat. No. 3,929,678 issued to Laughlin and Heuring on Dec. 30, 1975. Further examples are given in “Surface Active Agents and Detergents” (Vol. I and II by Schwartz, Perry and Berch), which is herein incorporated by reference in its entirety.

Cationic Surfactants

Surface active substances are classified as cationic if the charge on the hydrotrope portion of the molecule is positive. Surfactants in which the hydrotrope carries no charge unless the pH is lowered close to neutrality or lower, but which are then cationic (e.g. alkyl amines), are also included in this group. In theory, cationic surfactants may be synthesized from any combination of elements containing an “onium” structure RnX+Y— and could include compounds other than nitrogen (ammonium) such as phosphorus (phosphonium) and sulfur (sulfonium). In practice, the cationic surfactant field is dominated by nitrogen containing compounds, probably because synthetic routes to nitrogenous cationics are simple and straightforward and give high yields of product, which can make them less expensive.

Cationic surfactants preferably include, more preferably refer to, compounds containing at least one long carbon chain hydrophobic group and at least one positively charged nitrogen. The long carbon chain group may be attached directly to the nitrogen atom by simple substitution; or more preferably indirectly by a bridging functional group or groups in so-called interrupted alkylamines and amido amines. Such functional groups can make the molecule more hydrophilic and/or more water dispersible, more easily water solubilized by co-surfactant mixtures, and/or water soluble. For increased water solubility, additional primary, secondary or tertiary amino groups can be introduced, or the amino nitrogen can be quaternized with low molecular weight alkyl groups. Further, the nitrogen can be a part of branched or straight chain moiety of varying degrees of unsaturation or of a saturated or unsaturated heterocyclic ring. In addition, cationic surfactants may contain complex linkages having more than one cationic nitrogen atom.

The surfactant compounds classified as amine oxides, amphoterics and zwitterions are themselves typically cationic in near neutral to acidic pH solutions and can overlap surfactant classifications. Polyoxyethylated cationic surfactants generally behave like nonionic surfactants in alkaline solution and like cationic surfactants in acidic solution. The simplest cationic amines, amine salts and quaternary ammonium compounds can be schematically drawn thus:

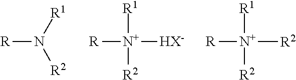

in which, R represents a long alkyl chain, R′, R″, and R′ may be either long alkyl chains or smaller alkyl or aryl groups or hydrogen and X represents an anion. The majority of large volume commercial cationic surfactants can be subdivided into four major classes and additional sub-groups known to those or skill in the art and described in “Surfactant Encyclopedia”, Cosmetics & Toiletries, Vol. 104 (2) 86-96 (1989), which is herein incorporated by reference in its entirety. The first class includes alkylamines and their salts. The second class includes alkyl imidazolines. The third class includes ethoxylated amines. The fourth class includes quaternaries, such as alkylbenzyldimethylammonium salts, alkyl benzene salts, heterocyclic ammonium salts, tetra alkylammonium salts, and the like. Cationic surfactants are known to have a variety of properties that can be beneficial in the present compositions. These desirable properties can include detergency in compositions of or below neutral pH, antimicrobial efficacy, thickening or gelling in cooperation with other agents, and the like. Suitable cationic surfactants include, without limitation, those having the formula R¹mR²xYLZ wherein each R¹ is an organic group containing a straight or branched alkyl or alkenyl group optionally substituted with up to three phenyl or hydroxy groups and optionally interrupted by up to four of the following structures

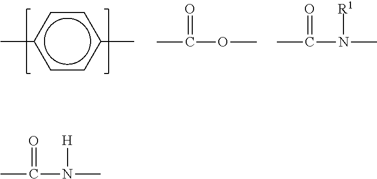

or an isomer or mixture of these structures, and which contains from about 8 to 22 carbon atoms. The R¹ groups can additionally contain up to 12 ethoxy groups. m is a number from 1 to 3. Preferably, no more than one R¹ group in a molecule has 16 or more carbon atoms when m is 2 or more than 12 carbon atoms when m is 3. Each R² is an alkyl or hydroxyalkyl group containing from 1 to 4 carbon atoms or a benzyl group with no more than one R² in a molecule being benzyl. x is a number from 0 to 11, preferably from 0 to 6. The remainder of any carbon atom positions on the Y group are filled by hydrogens. Y can be a group including, but not limited to:

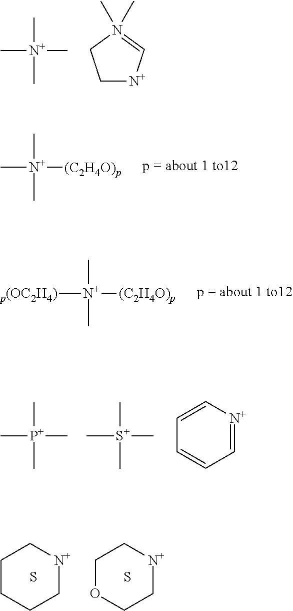

or a mixture thereof. Preferably, L is 1 or 2, with the Y groups being separated by a moiety selected from R¹ and R² analogs (preferably alkylene or alkenylene) having from 1 to about 22 carbon atoms and two free carbon single bonds when L is 2. Z is a water-soluble anion, such as a halide, sulfate, methylsulfate, hydroxide, or nitrate anion, particularly preferred being chloride, bromide, iodide, sulfate or methyl sulfate anions, in a number to give electrical neutrality of the cationic component.

Zwitterionic Surfactants

Zwitterionic surfactants can be thought of as a subset of the amphoteric surfactants and can include an anionic charge. Zwitterionic surfactants can be broadly described as derivatives of secondary and tertiary amines, derivatives of heterocyclic secondary and tertiary amines, or derivatives of quaternary ammonium, quaternary phosphonium or tertiary sulfonium compounds. Typically, a zwitterionic surfactant includes a positive charged quaternary ammonium or, in some cases, a sulfonium or phosphonium ion; a negative charged carboxyl group; and an alkyl group. Zwitterionics generally contain cationic and anionic groups which ionize to a nearly equal degree in the isoelectric region of the molecule and which can develop strong “inner-salt” attraction between positive-negative charge centers. Examples of such zwitterionic synthetic surfactants include derivatives of aliphatic quaternary ammonium, phosphonium, and sulfonium compounds, in which the aliphatic radicals can be straight chain or branched, and wherein one of the aliphatic substituents contains from 8 to 18 carbon atoms and one contains an anionic water solubilizing group, e.g., carboxy, sulfonate, sulfate, phosphate, or phosphonate.

Betaine and sultaine surfactants are exemplary zwitterionic surfactants for use herein. A general formula for these compounds is:

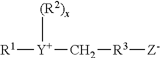

wherein R¹ contains an alkyl, alkenyl, or hydroxyalkyl radical of from 8 to 18 carbon atoms having from 0 to 10 ethylene oxide moieties and from 0 to 1 glyceryl moiety; Y is selected from the group consisting of nitrogen, phosphorus, and sulfur atoms; R² is an alkyl or monohydroxy alkyl group containing 1 to 3 carbon atoms; x is 1 when Y is a sulfur atom and 2 when Y is a nitrogen or phosphorus atom, R³ is an alkylene or hydroxy alkylene or hydroxy alkylene of from 1 to 4 carbon atoms and Z is a radical selected from the group consisting of carboxylate, sulfonate, sulfate, phosphonate, and phosphate groups.

Examples of zwitterionic surfactants having the structures listed above include: 4-[N,N-di(2-hydroxyethyl)-N-octadecylammonio]-butane-1-carboxylate; 5-[S-3-hydroxypropyl-S-hexadecylsulfonio]-3-hydroxypentane-1-sulfate; 3-[P,P-diethyl-P-3,6,9-trioxatetracosanephosphonio]-2-hydroxypropane-1-phosphate; 3-[N,N-dipropyl-N-3-dodecoxy-2-hydroxypropyl-ammonio]-propane-1-phosphonate; 3-(N,N-dimethyl-N-hexadecylammonio)-propane-1-sulfonate; 3-(N,N-dimethyl-N-hexadecylammonio)-2-hydroxy-propane-1-sulfonate; 4-[N,N-di(2(2-hydroxyethyl)-N(2-hydroxydodecyl)ammonio]-butane-1-carboxylate; 3-[S-ethyl-S-(3-dodecoxy-2-hydroxypropyl)sulfonio]-propane-1-phosphate; 3-[P,P-dimethyl-P-dodecylphosphonio]-propane-1-phosphonate; and S[N,N-di(3-hydroxypropyl)-N-hexadecylammonio]-2-hydroxy-pentane-1-sulfate. The alkyl groups contained in said detergent surfactants can be straight or branched and saturated or unsaturated.

The zwitterionic surfactant suitable for use in the present compositions includes a betaine of the general structure:

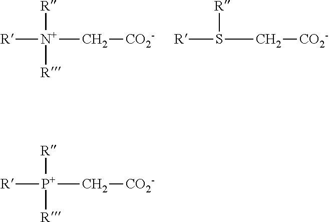

These surfactant betaines typically do not exhibit strong cationic or anionic characters at pH extremes, nor do they show reduced water solubility in their isoelectric range. Unlike “external” quaternary ammonium salts, betaines are compatible with anionics. Examples of suitable betaines include coconut acylamidopropyldimethyl betaine; hexadecyl dimethyl betaine; C₁₂₋₁₄ acylamidopropylbetaine; C₈₋₁₄ acylamidohexyldiethyl betaine; 4-C₁₄₋₁₆ acylmethylamidodiethylammonio-1-carboxybutane; C₁₆₋₁₈ acylamidodimethylbetaine; C₁₂₋₁₆ acylamidopentanediethylbetaine; and C₁₂₋₁₆ acylmethylamidodimethylbetaine.

Suitable sultaines may include, without limitation, those compounds having the formula (R(R¹)₂N⁺R²SO³⁻, in which R is a C₆-C₁₈ hydrocarbyl group, each R¹ is typically independently C₁-C₃ alkyl, e.g. methyl, and R² is a C₁-C₆ hydrocarbyl group, e.g. a C₁-C₃ alkylene or hydroxyalkylene group.

A typical listing of zwitterionic classes, and species of these surfactants, is given in U.S. Pat. No. 3,929,678, which is herein incorporated by reference in its entirety. Further examples are given in “Surface Active Agents and Detergents” (Vol. I and II by Schwartz, Perry and Berch), which is herein incorporated by reference in its entirety.

Corrosion Inhibitor/Etch Protector

In some embodiments, the detergent compositions described herein include one or more etch protectors for preventing corrosion of a surface and/or one or more corrosion inhibitors for addressing calcium carbonate-based scale or other types of mineral scale, including calcium sulfate, calcium phosphate, barium sulfate, strontium sulfate, iron hydroxide, silicone dioxide (silica), calcium oxalate, and others. Examples of suitable corrosion inhibitors/etch protectors include but are not limited to: a combination of a source of aluminum ion and a source of zinc ion, as well as an alkaline metal silicate or hydrate thereof.

The corrosion inhibitor/etch protector can refer to the combination of a source of aluminum ion and a source of zinc ion. The source of aluminum ion and the source of zinc ion provide aluminum ion and zinc ion, respectively, when the solid detergent composition is provided in the form of a use solution. The amount of the corrosion inhibitor/etch protector is calculated based upon the combined amount of the source of aluminum ion and the source of zinc ion. Anything that provides an aluminum ion in a use solution can be referred to as a source of aluminum ion, and anything that provides a zinc ion when provided in a use solution can be referred to as a source of zinc ion. It is not necessary for the source of aluminum ion and/or the source of zinc ion to react to form the aluminum ion and/or the zinc ion. Aluminum ions can be considered a source of aluminum ion, and zinc ions can be considered a source of zinc ion. The source of aluminum ion and the source of zinc ion can be provided as organic salts, inorganic salts, and mixtures thereof.

Exemplary sources of aluminum ion include but are not limited to: aluminum salts such as sodium aluminate, aluminum bromide, aluminum chlorate, aluminum chloride, aluminum iodide, aluminum nitrate, aluminum sulfate, aluminum acetate, aluminum formate, aluminum tartrate, aluminum lactate, aluminum oleate, aluminum bromate, aluminum borate, aluminum potassium sulfate, and aluminum zinc sulfate. Exemplary sources of zinc ion include, but are not limited to: zinc salts such as zinc chloride, zinc sulfate, zinc nitrate, zinc iodide, zinc thiocyanate, zinc fluorosilicate, zinc dichromate, zinc chlorate, sodium zincate, zinc gluconate, zinc acetate, zinc benzoate, zinc citrate, zinc lactate, zinc formate, zinc bromate, zinc bromide, zinc fluoride, zinc fluorosilicate, and zinc salicylate.

In some embodiments, the detergent compositions contain one or more corrosion inhibitors present in an amount of between about 0.001 wt. % to about 10 wt. %, preferably between about 0.001 wt. % to about 5 wt. %, more preferably between about 0.01 wt. % to about 1 wt. %, most preferably between about 0.01 wt. % to about 0.04 wt. %

Antimicrobial Agents

The detergent compositions may optionally further comprise one or more antimicrobial agents. Any suitable antimicrobial agent or combination of antimicrobial agents may be used including, but not limited to, a bleaching agent such as sodium hypochlorite; hydrogen peroxide; a peracid such as peracetic acid, performic acid, peroctanoic acid, sulfoperoxyacids, and any peracid generated from a carboxylic acid and oxidants; and/or a quaternary ammonium acid.

Some examples of classes of compounds that can act as sources of chlorine for an antimicrobial agent include a hypochlorite, a chlorinated phosphate, a chlorinated isocyanurate, a chlorinated melamine, a chlorinated amide, and the like, or mixtures of combinations thereof.

Some specific examples of sources of chlorine can include sodium hypochlorite, potassium hypochlorite, calcium hypochlorite, lithium hypochlorite, chlorinated trisodiumphosphate, sodium dichloroisocyanurate, potassium dichloroisocyanurate, pentaisocyanurate, trichloromelamine, sulfondichloro-amide, 1,3-dichloro 5,5-dimethyl hydantoin, N-chlorosuccinimide, N,N′-dichloroazodicarbonimide, N,N′-chloroacetylurea, N,N′-dichlorobiuret, trichlorocyanuric acid and hydrates thereof, or combinations or mixtures thereof.

In some embodiments, the composition is free of chlorine.

Any suitable peracid or peroxycarboxylic acid may be used as an antimicrobial agent. A peracid includes any compound of the formula R—(COOOH)n in which R can be hydrogen, alkyl, alkenyl, alkyne, acylic, alicyclic group, aryl, heteroaryl, or heterocyclic group, and n is 1, 2, or 3, and named by prefixing the parent acid with peroxy. Preferably R includes hydrogen, alkyl, or alkenyl. The terms “alkyl,” “alkenyl,” “alkyne,” “acylic,” “alicyclic group,” “aryl,” “heteroaryl,” and “heterocyclic group” are as defined herein.

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups). Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups. In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

The term “alkenyl” includes an unsaturated aliphatic hydrocarbon chain having from 2 to 12 carbon atoms, such as, for example, ethenyl, 1-propenyl, 2-propenyl, 1-butenyl, 2-methyl-1-propenyl, and the like. The alkyl or alkenyl can be terminally substituted with a heteroatom, such as, for example, a nitrogen, sulfur, or oxygen atom, forming an aminoalkyl, oxyalkyl, or thioalkyl, for example, aminomethyl, thioethyl, oxypropyl, and the like. Similarly, the above alkyl or alkenyl can be interrupted in the chain by a heteroatom forming an alkylaminoalkyl, alkylthioalkyl, or alkoxyalkyl, for example, methylaminoethyl, ethylthiopropyl, methoxymethyl, and the like.

Further, as used herein the term “alicyclic” includes any cyclic hydrocarbyl containing from 3 to 8 carbon atoms. Examples of suitable alicyclic groups include cyclopropanyl, cyclobutanyl, cyclopentanyl, etc. The term “heterocyclic” includes any closed ring structures analogous to carbocyclic groups in which one or more of the carbon atoms in the ring is an element other than carbon (heteroatom), for example, a nitrogen, sulfur, or oxygen atom. Heterocyclic groups may be saturated or unsaturated. Examples of suitable heterocyclic groups include for example, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan. Additional examples of suitable heterocyclic groups include groups derived from tetrahydrofurans, furans, thiophenes, pyrrolidines, piperidines, pyridines, pyrrols, picoline, coumaline, etc.

In some embodiments, alkyl, alkenyl, alicyclic groups, and heterocyclic groups can be unsubstituted or substituted by, for example, aryl, heteroaryl, C₁₋₄ alkyl, C₁₋₄ alkenyl, C₁₋₄ alkoxy, amino, carboxy, halo, nitro, cyano, —SO₃H, phosphono, or hydroxy. When alkyl, alkenyl, alicyclic group, or heterocyclic group is substituted, preferably the substitution is C₁₋₄ alkyl, halo, nitro, amido, hydroxy, carboxy, sulpho, or phosphono. In one embodiment, R includes alkyl substituted with hydroxy. The term “aryl” includes aromatic hydrocarbyl, including fused aromatic rings, such as, for example, phenyl and naphthyl. The term “heteroaryl” includes heterocyclic aromatic derivatives having at least one heteroatom such as, for example, nitrogen, oxygen, phosphorus, or sulfur, and includes, for example, furyl, pyrrolyl, thienyl, oxazolyl, pyridyl, imidazolyl, thiazolyl, isoxazolyl, pyrazolyl, isothiazolyl, etc. The term “heteroaryl” also includes fused rings in which at least one ring is aromatic, such as, for example, indolyl, purinyl, benzofuryl, etc.

In some embodiments, aryl and heteroaryl groups can be unsubstituted or substituted on the ring by, for example, aryl, heteroaryl, alkyl, alkenyl, alkoxy, amino, carboxy, halo, nitro, cyano, —SO₃H, phosphono, or hydroxy. When aryl, aralkyl, or heteroaryl is substituted, preferably the substitution is C₁₋₄ alkyl, halo, nitro, amido, hydroxy, carboxy, sulpho, or phosphono. In one embodiment, R includes aryl substituted with C₁₋₄ alkyl.

The peroxycarboxylic acid compositions suitable for use can include any C₁-C₂₂ peroxycarboxylic acid, including mixtures of peroxycarboxylic acids, including for example, peroxyformic acid, peroxyacetic acid, peroxyoctanoic acid and/or peroxysulfonated oleic acid. As used herein, the term “peracid” may also be referred to as a “percarboxylic acid,” “peroxycarboxylic acid” or “peroxyacid.” Sulfoperoxycarboxylic acids, sulfonated peracids and sulfonated peroxycarboxylic acids are also included within the terms “peroxycarboxylic acid” and “peracid” as used herein. The terms “sulfoperoxycarboxylic acid,” “sulfonated peracid,” or “sulfonated peroxycarboxylic acid” refers to the peroxycarboxylic acid form of a sulfonated carboxylic acid as disclosed in U.S. Pat. Nos. 8,344,026 and 8,809,392, and U.S. Patent Publication No. 2012/0052134, each of which are incorporated herein by reference in their entirety. As one of skill in the art appreciates, a peracid refers to an acid having the hydrogen of the hydroxyl group in carboxylic acid replaced by a hydroxy group. Oxidizing peracids may also be referred to herein as peroxycarboxylic acids.

Another type of suitable antimicrobial agent is quaternary ammonium compounds. The term “quaternary ammonium compound” or “quat” generally refers to any composition with the following formula:

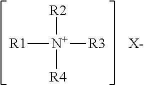

where R1-R4 are alkyl groups that may be alike or different, substituted or unsubstituted, saturated or unsaturated, branched or unbranched, and cyclic or acyclic and may contain ether, ester, or amide linkages; they may be aromatic or substituted aromatic groups. In an aspect, groups R1, R2, R3, and R4 each generally having a C1-C20 chain length. X— is an anionic counterion. The term “anionic counterion” includes any ion that can form a salt with quaternary ammonium. Examples of suitable counterions include halides such as chlorides and bromides, propionates, methosulphates, saccharinates, ethosulphates, hydroxides, acetates, phosphates, carbonates (such as commercially available as Carboquat H, from Lonza), and nitrates. Preferably, the anionic counterion is chloride.

Examples of suitable quaternary ammonium compounds include but are not limited to dialkyldimethylamines and ammonium chlorides like alkyl dimethyl benzyl ammonium chloride, octyl decyl dimethyl ammonium chloride, dioctyl dimethyl ammonium chloride, and didecyl dimethyl ammonium chloride to name a few. A single quaternary ammonium or a combination of more than one quaternary ammonium may be included in embodiments of the solid compositions. Further examples of quaternary ammonium compounds include but are not limited to amidoamine, imidozoline, epichlorohydrin, benzethonium chloride, ethylbenzyl alkonium chloride, myristyl trimethyl ammonium chloride, methyl benzethonium chloride, cetalkonium chloride, cetrimonium bromide (CTAB), carnitine, dofanium chloride, tetraethyl ammonium bromide (TEAB), domiphen bromide, benzododecinium bromide, benzoxonium chloride, choline, cocamidopropyl betaine (CAPB), denatonium, and mixtures thereof.

Additional Functional Ingredients

The components of the detergent composition may optionally be combined with various additional functional ingredients. The functional ingredients provide desired properties and functionalities to the detergent composition. For the purpose of this application, the term “functional ingredients” includes an ingredient that when dispersed or dissolved in a use and/or concentrate, such as an aqueous solution, provides a beneficial property in a particular use. Some examples of functional ingredients are discussed in more detail below, although the particular materials discussed are given by way of example only, and that a broad variety of other functional ingredients may be used. For example, many of the functional ingredients discussed below relate to materials used in cleaning applications. However, other embodiments may include functional ingredients for use in other applications.

Exemplary additional functional ingredients include for example: builders or water conditioners, including detergent builders; hardening agents; bleaching agents; fillers; defoaming agents; anti-redeposition agents; stabilizing agents; dispersants; enzymes; glass and metal corrosion inhibitors; fragrances and dyes; thickeners; etc. Further description of suitable additional functional ingredients is set forth in U.S. Pat. No. 8,748,364 which is incorporated herein by reference in its entirety.

For example, the compositions may include various aesthetic enhancing agents, such as dyes and odorants including perfumes, and other aesthetic enhancing agents can be included in the composition. Dyes may be included to alter the appearance of the composition, as for example, Direct Blue 86 (Miles), Fastusol Blue (Mobay Chemical Corp.), Acid Orange 7 (American Cyanamid), Basic Violet 10 (Sandoz), Acid Yellow 23 (GAF), Acid Yellow 17 (Sigma Chemical), Sap Green (Keystone Analine and Chemical), Metanil Yellow (Keystone Analine and Chemical), Acid Blue 9 (Hilton Davis), Sandolan Blue/Acid Blue 182 (Sandoz), Hisol Fast Red (Capitol Color and Chemical), Fluorescein (Capitol Color and Chemical), and Acid Green 25 (Ciba-Geigy).

Fragrances or perfumes that may be included in the compositions include, for example, terpenoids such as citronellol, aldehydes such as amyl cinnamaldehyde, a jasmine such as C1S-jasmine or jasmal, and vanillin.

The one or more additional functional ingredients may be present in an amount of up to about 85 wt. %, preferably between 0.001 wt. % and 65 wt. %, more preferably in an amount of between 0.001 wt. % to about 30 wt. %, most preferably 0.001 wt. % to about 20 wt. %.

### Forms of the Composition

The detergent compositions described herein may be formulated into solids, liquids, pastes, and/or gels.

The components used to form the concentrated detergent composition can include an aqueous medium such as water as an aid in processing. It is expected that the aqueous medium will help provide the components with a desired viscosity for processing. In addition, it is expected that the aqueous medium may help in the solidification process when is desired to form the concentrated detergent composition as a solid. When the concentrated detergent composition is provided as a solid, it can, for example, be provided in the form of a block or pellet. It is expected that blocks will have a size of at least about 5 grams, and can include a size of greater than about 50 grams. It is expected that the concentrated detergent composition will include water in an amount of 1 to 50% by weight, preferably 2 to 20% by weight.

The detergent compositions may be provided as a liquid, including liquid concentrates. When provided as a concentrate, the compositions may be diluted to form use compositions. In general, a concentrate refers to a composition that is intended to be diluted with water to provide a use solution that contacts an object to provide the desired cleaning, rinsing, or the like. The detergent composition that contacts the articles to be washed can be referred to as a concentrate or a use composition (or use solution) dependent upon the formulation employed in methods as described herein.

A use solution may be prepared from the concentrate by diluting the concentrate with water at a dilution ratio that provides a use solution having desired detersive properties. The water that is used to dilute the concentrate to form the use composition can be referred to as water of dilution or a diluent and can vary from one location to another. Preferably, the concentrated detergent composition is diluted at a concentration of 0.1 to 10 g/l, preferably 0.5 to 5 g/l, most preferably 1 to 4 g/l to provide a use solution.

In addition to liquids, the detergents of the application may be provided as solids. Solid detergent compositions provide certain commercial advantages. For example, use of concentrated solid detergent compositions decrease shipment costs as a result of the compact solid form, in comparison to bulkier liquid products. In certain embodiments, solid products may be provided in the form of a multiple-use solid, such as, a block or a plurality of pellets, and can be repeatedly used to generate aqueous use solutions of the detergent composition for multiple cycles or a predetermined number of dispensing cycles. In certain embodiments, the solid detergent compositions may have a mass greater than about 5 grams, such as for example from about 5 grams to 10 kilograms. In certain embodiments, a multiple-use form of the solid detergent composition has a mass of about 1 kilogram to about 10 kilogram or greater.

Suitable solid compositions produced according to the application may take a variety of forms including but not limited to granular and pelletized solid compositions, flakes, powders, granules, pellets, tablets, lozenges, pucks, briquettes, bricks, unit doses, flowable solids, and/or block compositions, whether pressed, extruded, or cast.

In a pressed solid process, a flowable solid, such as granular solids or other particle solids are combined under pressure to form the solid composition. In a pressed solid process, flowable solids of the compositions are placed into a form (e.g., a mold or container). The method can include gently pressing the flowable solid in the form to produce the solid cleaning composition. Pressure may be applied by a block machine or a turntable press, or the like.

The detergent compositions may optionally be cured to produce the solid compositions. As referred to herein, an uncured composition including the flowable solid is compressed to provide sufficient surface contact between particles making up the flowable solid that the uncured composition will solidify into a stable solid composition. A sufficient quantity of particles (e.g. granules) in contact with one another provides binding of particles to one another effective for making a stable solid composition. Inclusion of a curing step may include allowing the pressed solid to solidify for a period of time, such as a few hours, or about 1 day (or longer). In additional aspects, the methods could include vibrating the flowable solid in the form or mold, such as the methods disclosed in U.S. Pat. No. 8,889,048, which is herein incorporated by reference in its entirety.

The use of pressed solids provides numerous benefits over conventional solid block or tablet compositions requiring high pressure in a tablet press, or casting requiring the melting of a composition consuming significant amounts of energy, and/or by extrusion requiring expensive equipment and advanced technical know-how. Pressed solids overcome such various limitations of other solid formulations for which there is a need for making solid compositions. Moreover, pressed solid compositions retain its shape under conditions in which the composition may be stored or handled.

In an embodiment, the detergent compositions of the application may be provided in the form of pellets. In an aspect, pelletized materials can be formed by compressing the solid granular or agglomerated complex of urea and acid in appropriate pelletizing equipment to result in appropriately sized pelletized materials. Solid block and cast solid block materials can be made by introducing into a container either a pre-hardened block or a solid block that hardens within a container. Preferred containers include disposable plastic containers or water-soluble film containers. Other suitable packaging for the composition includes flexible bags, packets, shrink wrap, and water-soluble film such as polyvinyl alcohol.

In other aspects, the solid compositions may be formed using a batch or continuous mixing system to combine the materials described herein. In an exemplary embodiment, a single- or twin-screw extruder is used to combine and mix one or more components at high shear to form a homogeneous mixture. In some embodiments, the processing temperature is at or below the melting temperature of the components. The processed mixture may be dispensed from the mixer by forming, casting or other suitable means, whereupon the detergent composition hardens to a solid form. Generally, a solid composition processed according to these methods is substantially homogeneous with regard to the distribution of ingredients throughout its mass and is dimensionally stable.

In an extrusion process, the components of the composition are introduced into final mixing system and are continuously mixed until the components form a substantially homogeneous semi-solid mixture in which the components are distributed throughout its mass. The mixture is then discharged from the mixing system into, or through, a die or other shaping means. The product is then packaged. In an exemplary embodiment, the formed composition begins to harden to a solid form.

In a casting process, the components of the composition are introduced into the final mixing system and are continuously mixed until the components form a substantially homogeneous liquid mixture in which the components are distributed throughout its mass. Once the mixing is complete, the product is transferred to a packaging container where solidification takes place. In an exemplary embodiment, the cast composition begins to harden to a solid form.

### Methods of Use

The detergent compositions described herein are suitable for use in various applications and methods, including any application suitable for a detergent composition. More particularly, the detergent compositions described herein may be used in any industry where use of an alkaline detergent is desired and where it is beneficial to remove soil and especially starch-based soil from a surface. The methods described herein facilitate soil removal, particularly starch soil removal, on treated substrate surfaces beneficially cleaning a surface and preventing soil buildup.

Methods of use employing the detergent compositions described herein are particularly suitable for institutional ware washing. Exemplary disclosure of warewashing applications is set forth in U.S. patent application Ser. Nos. 13/474,771, 13/474,780 and 13/112,412, including all references cited therein, which are herein incorporated by reference in its entirety. The method may be carried out in any consumer or institutional dish machine, including for example those described in U.S. Pat. No. 8,092,613, which is incorporated herein by reference in its entirety, including all figures and drawings. Some non-limiting examples of dish machines include door machines or hood machines, conveyor machines, undercounter machines, glasswashers, flight machines, pot and pan machines, utensil washers, and consumer dish machines. The dish machines may be either single tank or multi-tank machines.

A door dish machine, also called a hood dish machine, refers to a commercial dish machine wherein the soiled dishes are placed on a rack and the rack is then moved into the dish machine. Door dish machines clean one or two racks at a time. In such machines, the rack is stationary, and the wash and rinse arms move. A door machine includes two sets arms, a set of wash arms and a rinse arm, or a set of rinse arms.

Door machines may be a high temperature or low temperature machine. In a high temperature machine, the dishes are sanitized by hot water. In a low temperature machine, the dishes are sanitized by the chemical sanitizer. The door machine may either be a recirculation machine or a dump and fill machine. In a recirculation machine, the detergent solution is reused, or “recirculated” between wash cycles. The concentration of the detergent solution is adjusted between wash cycles so that an adequate concentration is maintained. In a dump and fill machine, the wash solution is not reused between wash cycles. New detergent solution is added before the next wash cycle. Some non-limiting examples of door machines include the Ecolab Omega HT, the Hobart AM-14, the Ecolab ES-2000, the Hobart LT-1, the CMA EVA-200, American Dish Service L-3DW and HT-25, the Autochlor A5, the Champion D-HB, and the Jackson Tempstar.

In an aspect, the detergent compositions are used as a warewashing detergent for the removal of starch soil at a temperature of 20° C. to 85° C., preferably from 50° C. to 75° C. The use of the described concentrated detergent composition as a warewashing detergent also allows for short washing times, which is defined as the time the warewashing detergent is contacted with the ware before it is rinsed off. Preferably the warewashing detergent is used for a washing time of 10 seconds to 5 minutes, preferably 15 seconds to 2 minutes, more preferably 30 to 60 seconds, most preferably 30 to 45 seconds.

In addition, the methods of use of the detergent compositions are also suitable for CIP and/or COP processes to replace the use of bulk detergents leaving hard water residues on treated surfaces. The methods of use may be desirable in additional applications where industrial standards are focused on the quality of the treated surface, such that the prevention of hard water scale accumulation provided by the detergent compositions. Such applications may include, but are not limited to, vehicle care, industrial, hospital and textile care.

Additional industries in which the detergent compositions may be of use include food and beverage applications, the restaurant/dining industry, textile care/laundry, the healthcare industry (e.g. hospitals, care facilities, clinics, etc.) and/or pest elimination. Examples of applications of use for the detergent compositions include, for example, alkaline detergents effective as grill and oven cleaners, ware wash detergents, laundry detergents, laundry presoaks, drain cleaners, hard surface cleaners, surgical instrument cleaners, transportation vehicle cleaning, vehicle cleaners, dish wash presoaks, dish wash detergents, beverage machine cleaners, concrete cleaners, building exterior cleaners, metal cleaners, floor cleaners, counter cleaners, table cleaners, degreasers, burned-on soil removers, textiles, and/or fabrics. In a variety of these applications, detergent compositions having a high alkalinity are most desirable and efficacious, however the damage caused by hard water scale accumulation is undesirable.

The various methods of use as described herein employ the use of the detergent composition, which may be formed prior to or at the point of use by combining the components of the detergent composition in the weight percentages disclosed herein. The detergent composition may be provided in various formulations. The methods of use may employ any of the formulations disclosed, including for example, liquids, semi-solids and/or other solid formulations as described herein.

The methods may also employ a concentrate and/or a use solution constituting an aqueous solution or dispersion of a concentrate as described herein. Such use solutions may be formed during the washing process such as during warewashing processes.

In aspects, employing packaged solid detergent compositions, the products may first require removal from any applicable packaging (e.g. film). Thereafter, according to certain methods of use, the compositions can be inserted directly into a dispensing apparatus and/or provided to a water source for cleaning. Examples of such dispensing systems include for example U.S. Pat. Nos. 4,826,661, 4,690,305, 4,687,121, 4,426,362 and U.S. Pat. Nos. Re 32,763 and 32,818, the disclosures of which are incorporated by reference herein in its entirety. Ideally, a solid detergent composition is configured or produced to closely fit the particular shape(s) of a dispensing system in order to prevent the introduction and dispensing of an incorrect solid product into the apparatus.

In certain embodiments, the detergent composition may be mixed with a water source prior to or at the point of use. In other embodiments, the detergent compositions do not require the formation of a use solution and/or further dilution and may be used without further dilution.

In aspects, employing solid detergent compositions, a water source contacts the detergent composition to convert solid detergent compositions, particularly powders, into use solutions. Additional dispensing systems may also be utilized which are more suited for converting alternative solid detergents compositions into use solutions. The methods include use of a variety of solid detergent compositions, including, for example, extruded blocks or “capsule” types of package.

In an aspect, a dispenser may be employed to spray water (e.g. in a spray pattern from a nozzle) to form a detergent use solution. For example, water may be sprayed toward an apparatus or other holding reservoir with the detergent composition, wherein the water reacts with the solid detergent composition to form the use solution. In certain embodiments of the methods, a use solution may be configured to drip downwardly due to gravity until the dissolved solution of the detergent composition is dispensed for use. In an aspect, the use solution may be dispensed into a wash solution of a ware wash machine.

All publications and patent applications in this specification are indicative of the level of ordinary skill in the art to which this disclosure pertains. All publications and patent applications are herein incorporated by reference to the same extent as if each individual publication or patent application was specifically and individually indicated as incorporated by reference.

### EXAMPLES

Embodiments of the compositions described herein are further defined in the following non-limiting Examples. It should be understood that these Examples, while indicating certain embodiments, are given by way of illustration only. From the above discussion and these Examples, one skilled in the art can ascertain the essential characteristics of the compositions and methods described herein, and without departing from the spirit and scope thereof, can make various changes and modifications of the embodiments to adapt it to various usages and conditions. Thus, various modifications of the embodiments, in addition to those shown and described herein, will be apparent to those skilled in the art from the foregoing description. Such modifications are also intended to fall within the scope of the appended claims.

### Example 1

A cleaning performance test was conducted to assess starch removal efficacy of a base detergent formulation, a detergent+bleach formulation, a detergent+enzyme formulation, and a detergent+bleach+enzyme formulation. These formulations are provided in Tables 3-6 below.

TABLE 3
Formulation A: Base Detergent Composition

| Component | Quantity (wt. %) |
|---|---|
| Dense Ash | 35-45 |
| Sodium tripolyphosphate | 15-25 |
| MGDA | 5-15 |
| GLDA (Na₄ Solution, 47%) | 1-8 |
| Sodium Aluminate (45%) | 0.1-0.5 |
| ATMP (50%) | 1-5 |
| Antarox 25-R-2 | 1-8 |

TABLE 4
Formulation B: Base Detergent + Bleach Composition

| Component | Quantity (wt. %) |
|---|---|
| Formulation A | ~85 |
| Sodium Percarbonate | 15 |
| Mn Catalyst | 0.025 |

TABLE 5
Formulation C: Base Detergent + Enzyme

| Component | Quantity (wt. %) |
|---|---|
| Formulation A | ~85 |
| Amylase (Termamyl 120T) | 1 |

TABLE 6
Formulation D: Base Detergent + Bleach + Enzyme
Composition

| Component | Quantity (wt. %) |
|---|---|
| Formulation A | ~85 |
| Sodium Percarbonate | 15 |
| Mn Catalyst | 0.025 |
| Amylase (Termamyl 120T) | 1 |

The soil removal test was conducted using melamine tiles (Testfabrics, Inc.) coated with potato starch (DM-79). The potato starch is colorless but bonded with an orange color to allow a quantitative soil removal measurement with a colorimeter.

Four starch-soiled melamine tiles were provided and their initial reflectance was recorded using a colorimeter (Mach 5, HunterLab) in order to assess a baseline of soiling. The tiles were then secured in holders and placed at a 45° angle in a Peggy dish rack. The tiles were washed in a door style dish machine (Hobart AM15, 53 L wash sump, 2.6 L rinse volume) for 10 cycles, where each cycle included a 38 second wash phase and a 10 second rinse phase (at 20 psi).

For the base detergent+bleach+enzyme composition, each cycle the composition was dosed at a concentration of 2.0 g/L. In between each individual cycle, 5% more detergent was added to maintain the detergent concentration. For the compositions without sodium percarbonate and the Mn catalyst, only 1.7 g/L detergent was added so that the concentrations of all other components were the same as the 2.0 g/L of the detergent+bleach+enzyme composition.

After completion of the wash cycle, a colorimeter was used to measure the percentage of soil removal. Percentage of soil removal was calculated according to the following formula:

% Soil Removal=[(L_{final}−Lᵢₙᵢₜᵢₐₗ)(L_{best}−Lᵢₙᵢₜᵢₐₗ)]*100

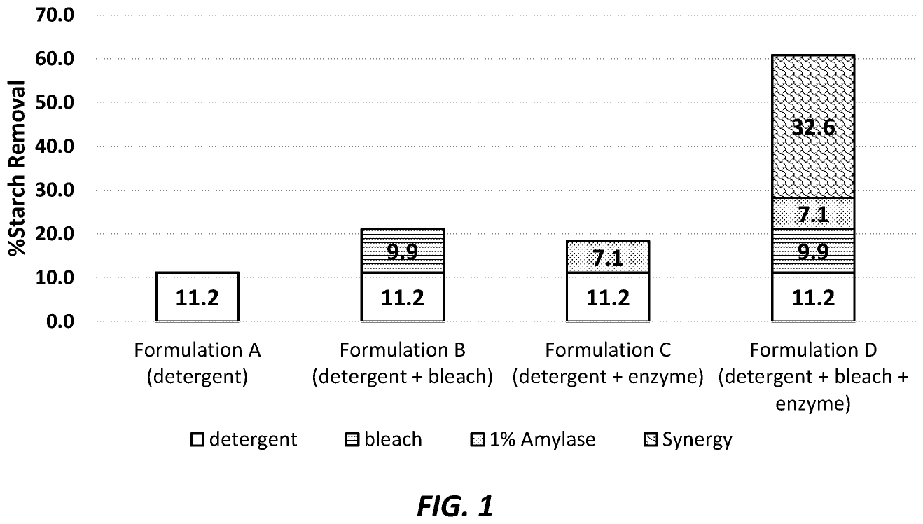

In this formula, “L” is the light-dark contrast value measured by the colorimeter, where L_{best}=88.05, Lᵢₙᵢₜᵢₐₗ is the light-dark contrast value before the wash cycle and L_{final} is the light-dark contrast value after the completion of all wash cycles. The results of this evaluation are depicted in Table 7 and FIG. 1.

TABLE 7
Soil Removal Efficacy

| Formulation | Soil Removal (%) |
|---|---|
| Formulation A (detergent) | 11.2% |
| Formulation B (detergent + bleach) | 21.1% |
| Formulation C (detergent + enzyme) | 18.3% |
| Formulation D (detergent + bleach + enzyme) | 60.8% |

As shown in Table 7 and FIG. 1, the base detergent provides an approximately 11% soil removal efficacy. Adding the bleach (sodium percarbonate and Mn catalyst) boosts soil removal efficacy by 9.9% (21.1%−11.2%=9.9%) beyond the soil removal of the detergent alone. Adding an amylase enzyme to the detergent boosts soil removal approximately 7% (18.3%−11.2%=7.1%). In view of these results the expected efficacy (based on merely additive efficacy) for the detergent+bleach+enzyme composition was approximately 28% (11.2%+9.9%+7.1%=28.2%). Surprisingly, however, the actual efficacy of the detergent+bleach+enzyme composition was 60.8%, more than double the expected soil removal. The substantial improvement in soil removal indicates an unexpected synergy between the detergent, bleach, and enzyme.

### Example 2

Given the surprising efficacy demonstrated through the combination of a detergent, bleach and enzyme, further evaluations were conducted to assess whether the exhibited synergy is applicable to all amylases. The same comparative formulas (Formulas A and B) were prepared according to the tables in Example 1. An additional detergent+bleach composition and a detergent+bleach+enzyme composition were further prepared according to Table 8 and Table 9, using a different amylase enzyme.

TABLE 8
Formulation E: Base Detergent + Enzyme Composition

| Component | Quantity (wt. %) |
|---|---|
| Formulation A | ~85 |
| Amylase (Achieve Choice 150T) | 0.5 |

TABLE 9
Formulation F: Base Detergent + Bleach + Enzyme Composition

| Component | Quantity (wt. %) |
|---|---|
| Formulation A | ~85 |
| Sodium Percarbonate | 15 |
| Mn Catalyst | 0.025 |
| Amylase (Achieve Choice 150T) | 0.5 |

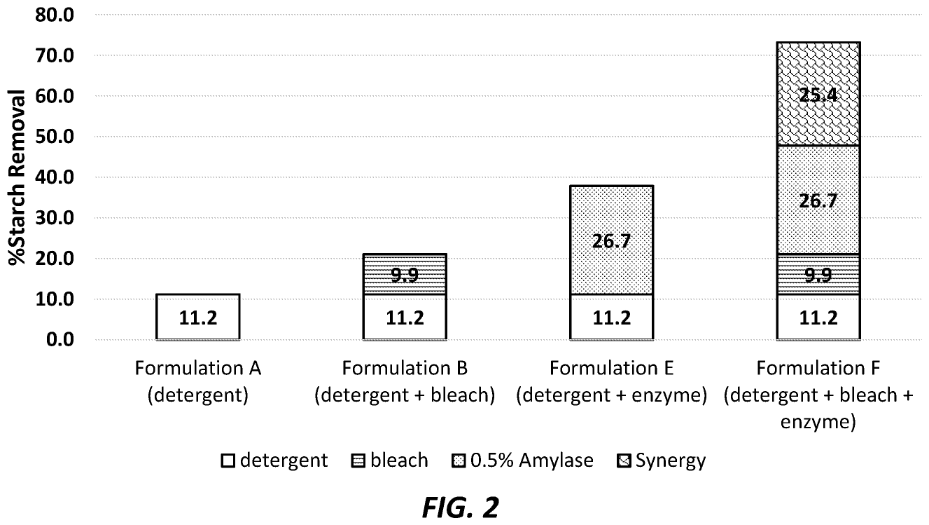

The formulations A, B, E, and F were evaluated using the procedure outlined in Example 1. The results of this evaluation are shown below in Table 10 as well as in FIG. 2.

TABLE 10
Soil Removal Efficacy

| Formulation | Soil Removal (%) |
|---|---|
| Formulation A (detergent) | 11.2% |
| Formulation B (detergent + bleach) | 21.1% |
| Formulation E (detergent + enzyme) | 37.9% |
| Formulation F (detergent + bleach + enzyme) | 73.2% |

As shown in Table 10 the Achieve Choice 150T provided an additional 26.7% boost in soil removal beyond the base soil removal of the detergent composition alone (37.9%−11.2%=26.7%). Consistent with Example 1, the addition of the bleach composition improved soil removal by 9.9% beyond the soil removal of the detergent composition alone 21.1%−11.2%=9.9%). As such, the expected efficacy (based on merely additive efficacy) for the detergent+bleach+enzyme composition was approximately 47.8% (11.2%+9.9%+26.7%=47.8%). Surprisingly, however, the actual efficacy of the detergent+bleach+enzyme composition was 73.2%, more than a 50% increase in efficacy compared to the expected value. The substantial improvement in soil removal confirms an unexpected synergy between the detergent and bleach compositions described herein and all amylase enzymes.

### Example 3

Other commercially available detergent formulas were tested with the addition of amylases to assess whether an amylase could simply be added to any detergent composition to achieve synergy. An example composition as described herein was prepared along with four comparative compositions similar to commercially available inline detergent compositions. 10 ppm Termamyl 300L, a liquid form of Termamyl 120T, was added to the wash solution with 1000 ppm of each of the formulations.” These comparative compositions are shown in Tables 11-15 below.

TABLE 11
Formulation G

| Component | Quantity (wt. %) |
|---|---|
| Primary Alkalinity Source | 35-45 |
| Secondary Alkalinity Source | 10-20 |
| Aminocarboxylic Acid | 10-20 |
| Phosphonic Acid | 20-30 |
| Phosphonate | 1-5 |
| Nonionic Surfactant | 1-8 |
| Mn Catalyst | 0.01-0.3 |
| Corrosion Inhibitor | 0.1-1 |

TABLE 12
Comparative Composition 1

| Component | Quantity (wt. %) |
|---|---|
| Primary Alkalinity Source | 81 |
| Secondary Alkalinity Source | 1 |
| Water Conditioning Polymer | 7 |
| EO/PO Block Copolymer | 4 |
| Phosphonate | 1.5 |
| Aminocarboxylate | 2 |
| Corrosion Inhibitor | 2.5 |
| Emulsifier/Stabilizer | 1 |

TABLE 13
Comparative Composition 2

| Component | Quantity (wt. %) |
|---|---|
| Primary Alkalinity Source | 71 |
| Secondary Alkalinity Source | 2.5 |
| Polycarboxylic Acid Chelant | 4.5 |
| Phosphonic Acid | 1 |
| Nonionic Surfactant | 6 |
| Filler | 1 |
| Cellulose | 0.5 |
| Corrosion Inhibitor | 10 |
| Bleach | 1.5 |
| Water | 2 |

TABLE 14
Comparative Composition 3

| Component | Quantity (wt. %) |
|---|---|
| Primary Alkalinity Source | 20 |
| Secondary Alkalinity Source | 55 |
| Water Conditioning Agent | 12.5 |
| Nonionic Surfactant | 2 |
| Filler | 0.1 |
| Corrosion Inhibitor | 0.2 |
| Water | 10 |

TABLE 15
Comparative Composition 4

| Component | Quantity (wt. %) |
|---|---|
| Primary Alkalinity Source | 80 |
| Water Conditioning Agent | 7.5 |
| Nonionic Surfactant | 2 |
| Corrosion Inhibitor | 5 |
| Emulsifier/Stabilizer | 6 |

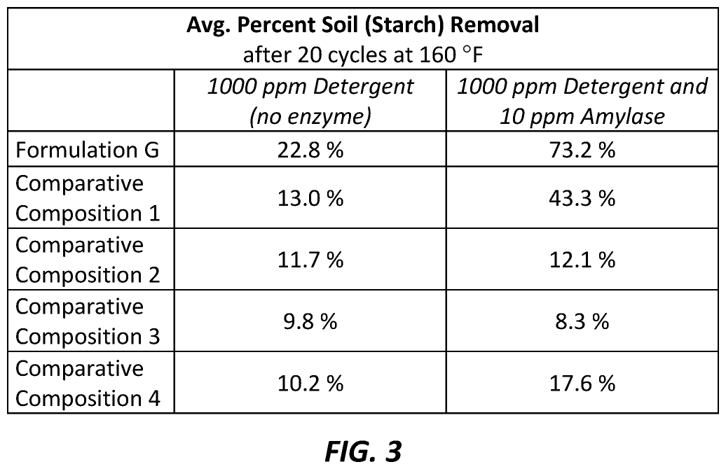

Formulation G and the comparative compositions were evaluated using the procedure outlined in Example 1, except that two trials were run for each composition, one where the dose concentration was 1000 ppm detergent and 10 ppm amylase, and another trial with 1000 ppm detergent but no amylase. This evaluation was conducted over a period of 20 wash cycles. The results of this evaluation are shown in FIG. 3 and Table 16.

TABLE 16
Soil Removal Efficacy

| | Soil Removal | Soil Removal |
|---|---|---|
| | Without | With |
| Composition | Amylase (%) | Amylase (%) |
| Formulation G | 22.8 | 73.2 |
| Comparative Composition 1 | 13.0 | 43.3 |
| Comparative Composition 2 | 11.7 | 12.1 |
| Comparative Composition 3 | 9.8 | 8.3 |
| Comparative Composition 4 | 10.2 | 17.6 |

FIG. 3 shows that the amylase is not compatible with all warewash formulas. Comparative Composition 1 is an enzyme-compatible ash-based detergent which demonstrates an improved soil removal performance upon addition of the amylase. However, the performance of Comparative Composition 1 is not synergistic and is substantially less than the soil removal of Formulation G. Comparative Composition 2 is a chlorine containing ash-based detergent. Without being bound by theory, it is thought that the amylase is incompatible with the chlorine: soil removal for Comparative Composition 3 only increased by 0.4% upon addition of the amylase. Comparative Composition 3 is a high caustic detergent. Without being bound by theory, it is thought the amylase is ineffective in the highly caustic conditions of Comparative Composition 3, as soil removal actually decreased upon addition of the amylase. Comparative Composition 4 is also an ash-based detergent. It is believed one or more components of Comparative Composition 4 are incompatible with the enzyme as soil removal efficacy only increased by about 7% with the addition of the amylase.

These data show merely additive and even negative interactions between inline detergent compositions and amylase enzymes. Given the minimal benefit provided by an enzyme in comparative compositions, it is unexpected that an amylase would synergistically interact with the detergent compositions described herein to dramatically improve soil removal. The synergistic efficacy is particularly surprising because starch-based soils are more difficult to remove than many other types of soils.

### Example 4

In addition to soil removal data, the compositions were evaluated for their stability as a solid under a variety of temperature conditions. Three humidity chambers were used to create these temperatures: a first at ambient temperature (72° F., 50% RH), a second at 100*F (65% RH), and a third at a temperature of 122° F. (<50% RH). Formulations D, F, and G as described in Examples 1-3 were formulated into solid blocks and blocks of each formulation were placed in the humidity chambers for a period of 8 weeks.

Formulations D, F, and G were also subjected to cyclical temperatures, simulating storage conditions, wherein the humidity chamber was kept at 80° F. (65% RH) for 11 hours, then over the course of an hour increased to 105° F. (30% RH), then maintained at 105° F. for another 11 hours, and finally decreased back to 80° F. (65% RH) over the course of an hour.

For both tests the solid blocks were evaluated for swelling (greater than 3%) and cracking. After 8 weeks of testing, Formulations D, F, and G exhibited good dimension stability: there were no substantial physical problems with the blocks.

The embodiments being thus described, it will be obvious that the same may be varied in many ways. Such variations are not to be regarded as a departure from the spirit and scope of the disclosure and all such modifications are intended to be included within the scope of the following claims.

What is claimed is:

1. A detergent composition comprising:
an alkalinity source;
one or more surfactants;
an amylase; and
one or more chelating agents;
an oxygen source;
a bleach activator, wherein the bleach activator comprises one or more compounds according to the Formulas (I), (II), (XIX) and (XX):
[(LₚM_{q})ₙXᵣ]Yₛ (Formula (I))
wherein each L independently is an organic ligand containing at least three nitrogen atoms and/or at least two carboxyl groups; wherein “M” is a metal, and wherein the metal is a transition metal; wherein “X” is a coordinating or bridging group, wherein “Y” is a counter ion, wherein “p” is an integer from 1 to 4, “q” is an integer from 1 to 2, “r” is an integer from 0 to 6, and “s” is the number of counter ions; 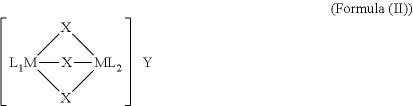
wherein L₁ and L₂ are separate ligands or where L₁ and L₂ are combined; wherein “M” is a metal, and wherein the metal is manganese or iron; wherein “Y” is a counter ion; and wherein “X” is a coordinating or bridging group;

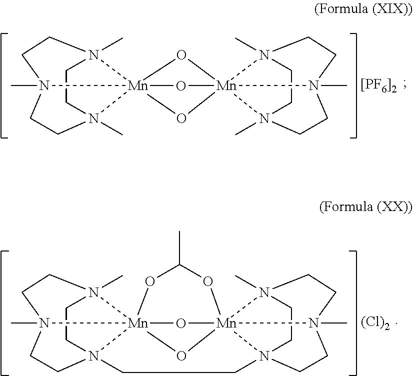

2. The detergent composition of claim 1, wherein the alkalinity source is an alkali metal carbonate.

3. The detergent composition of claim 1, wherein at least one of the one or more surfactants are a nonionic surfactant, and wherein the nonionic surfactant comprises a poloxamer.

4. The detergent composition of claim 3, further comprising one or more additional enzymes.

5. The detergent composition of claim 1, wherein the bleach composition is a peroxygen bleach.

6. The detergent composition of claim 5, wherein the peroxygen bleach is sodium percarbonate, sodium perborate, hydrogen peroxide, and/or a peracid.

7. The detergent composition of claim 1, wherein the bleach activator comprises Formula (I) and wherein the coordinating or bridging group is H₂O, OH⁻, SH⁻, HO₂⁻, O²⁻, O₂²⁻, S²⁻, F⁻, Cl⁻, Br, I⁻, NO₃⁻, NO₂⁻, SO₄²⁻, SO₃²⁻, PO₄³⁻, N₃⁻, CN⁻, NR₃, NCS⁻, RCN, RS⁻, RCO₂⁻, RO⁻, or 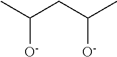
with R being hydrogen or a C₁ to C₆ alkyl group; or wherein the bleach activator comprises Formula (II) wherein the coordinating or bridging group is O²⁻, O₂²⁻, CH₃O—, CH₃CO²⁻, 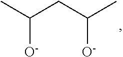
or Cl—.

8. The detergent composition of claim 1, wherein the one or more chelating agents comprise a phosphate and an aminocarboxylate.

9. The detergent composition of claim 8, wherein the phosphate is an alkali metal phosphate and the aminocarboxylate is EDTA, HEDTA, DTPA, EDDS, HEIDA, IDS, HIDS, MGDA and/or GLDA.

10. The detergent composition of claim 9, wherein the alkali metal phosphate is sodium orthophosphate, potassium orthophosphate, sodium pyrophosphate, potassium pyrophosphate, sodium tripolyphosphate, and/or sodium hexametaphosphate.

11. The detergent composition of claim 1, further comprising a corrosion inhibitor comprising sodium aluminate, aluminum bromide, aluminum chlorate, aluminum chloride, aluminum iodide, aluminum nitrate, aluminum sulfate, aluminum acetate, aluminum formate, aluminum tartrate, aluminum lactate, aluminum oleate, aluminum bromate, aluminum borate, aluminum potassium sulfate, aluminum zinc sulfate, zinc chloride, zinc sulfate, zinc nitrate, zinc iodide, zinc thiocyanate, zinc fluorosilicate, zinc dichromate, zinc chlorate, sodium zincate, zinc gluconate, zinc acetate, zinc benzoate, zinc citrate, zinc lactate, zinc formate, zinc bromate, zinc bromide, zinc fluoride, zinc fluorosilicate, and/or zinc salicylate.

12. The detergent composition of claim 1, further comprising one or more additional functional ingredients, wherein the one or more additional functional ingredients are builders or water conditioners, hardening agents, bleaching agents, thickening agents, fillers, defoaming agents, anti-redeposition agents, stabilizing agents, dispersants, enzymes, fragrances, and/or dyes.

13. The detergent composition of claim 1, comprising about 20 wt. % to about 60 wt. % of the alkalinity source; from about 5 wt. % to about 30 wt. % of the oxygen source; from about 0.001 wt. % to about 5 wt. % of the bleach activator; from about 0.01 wt. % to about 10 wt. % of the amylase; from about 0.5 wt. % to about 20 wt. % of the one or more nonionic surfactants; and from about 15 wt. % to about 60 wt. % of one or more chelants.

14. The detergent composition of claim 1, comprising about 40 wt. % to about 45 wt. % of the alkalinity source; from about 12 wt. % to about 18 wt. % of the oxygen source; from about 0.02 wt. % to about 0.03 wt. % of the bleach activator; from about 0.4 wt. % to about 1.1 wt. % of the amylase; from about 2 wt. % to about 6 wt. % of the one or more nonionic surfactants; and from about 35 wt. % to about 40 wt. % of one or more chelants.

15. The detergent composition of claim 14, wherein the one or more chelants includes about 20 wt. % to about 25 wt % of a phosphate, from about 10 wt. % to about 15 wt. % of an aminocarboxylate, and from about 1 wt. % to about 3 wt. % of a secondary aminocarboxylate.

16. The composition of claim 1, wherein the composition is a pressed solid or a flowable solid.

17. The composition of claim 1, wherein the composition is a liquid concentrate or a diluted use solution.

18. A method of cleaning a surface comprising:
combining the detergent composition of claim 1 with water to form a use solution; and
contacting the detergent composition with a surface, wherein the surface is soiled with a starch-based soil; wherein the composition removes the starch-based soil.

19. The method of claim 18, wherein the surface is a food processing surface and/or ware.

20. The method of claim 19, wherein the surface is ware and comprises one or more of an eating utensil, a plate, a bowl, a pot, a pan, glassware.

21. The method of claim 20, wherein the ware is glass, plastic, ceramic, and/or metal.
